(19) United States
(12) Patent Application Publication
(10) Pub. No.: US 2026/0141647 A1
(43) Pub. Date: May 21, 2026

(54) SYSTEMS AND METHODS FOR GENERATING AND PRESENTING 3D AND OTHER REPRESENTATIONS AND ASSOCIATED DATA

(71) Applicant: CoStar Realty Information, Inc., Arlington, VA (US)

(72) Inventors: David Alan Gausebeck, Sunnyvale, CA (US); Dorra Larnaout, Mountain View, CA (US); Arindam Ashim Bose, Arlington, VA (US); Satyasree Muralidharan, Austin, TX (US)

(73) Assignee: CoStar Realty Information, Inc., Arlington, VA (US)

(21) Appl. No.: 19/440,633

(22) Filed: Jan. 5, 2026

Related U.S. Application Data
(63) Continuation of application No. 19/336,197, filed on Sep. 22, 2025.
(60) Provisional application No. 63/697,285, filed on Sep. 20, 2024.

(51) Int. Cl. G06T 19/00; G06T 15/20

(52) U.S. Cl. CPC G06T 19/003; G06T 15/205; G06T 2200/24

(57) ABSTRACT

An example method includes receiving images of an environment. The environment may include a building. The images may be captured by an aerial drone. A 3D representation of the environment may be generated, based on the images. The 3D representation may include Gaussian splats representing the environment, including the building. Particular regions in the 3D representation in which a virtual camera for viewing the 3D representation may move as the 3D representation is navigated may be identified. The virtual camera may be constrained to move only in the particular regions. The particular regions may be less than an entirety of the 3D representation. The 3D representation may be provided for display. Inputs to navigate the 3D representation by moving the virtual camera in the 3D representation may be received. The virtual camera may be moved, based on the inputs, only in the particular regions in the 3D representation.

### CROSS-REFERENCE TO RELATED APPLICATION

This application is a continuation of, and seeks the benefit of U.S. Nonprovisional Application No. Ser. No. 19/336,197, filed on Sep. 22, 2025, and entitled “SYSTEMS AND METHODS FOR GENERATING AND PRESENTING 3D AND OTHER REPRESENTATIONS AND ASSOCIATED DATA,” which claims priority to and seeks the benefit of U.S. Provisional Ser. No. 63/697,285 , filed on Sep. 20, 2024, and entitled “SYSTEMS AND METHODS FOR MULTI-MODE PRESENTATION OF 3D CONTENT,” both of which are incorporated in their entirety herein by reference.

### TECHNICAL FIELD

The present disclosure relates in general to representations of real-world environments, and in particular to three-dimensional (3D) and other representations of real-world environments and data associated with such representations.

### BACKGROUND

Three-dimensional (3D) visualizations and walkthroughs typically enable users to view and/or engage with 3D models of a given environment. 3D model visualizations of a physical environment, such as a house, are becoming common. However, such 3D model visualizations may suffer from various deficiencies, such as only allowing a user to view an interior of a house, and not the house in the overall physical environment.

### SUMMARY

In some aspects, the techniques described herein relate to one or more non-transitory computer-readable media including executable instructions, the executable instructions being executable by one or more processors to perform a method, the method including: receiving images of an environment, the environment including a building, the images captured by an aerial drone; generating, based on the images, a 3D representation of the environment, the 3D representation including Gaussian splats representing the environment, including the building; identifying particular regions in the 3D representation in which a virtual camera for viewing the 3D representation may move as the 3D representation is navigated, the virtual camera constrained to move only in the particular regions, the particular regions less than an entirety of the 3D representation; providing the 3D representation for display; receiving inputs to navigate the 3D representation by moving the virtual camera in the 3D representation; and moving, based on the inputs, the virtual camera only in the particular regions in the 3D representation.

In some aspects, the techniques described herein relate to one or more non-transitory computer-readable media, the method further including identifying particular orientations that the virtual camera may have as the virtual camera moves in the particular regions in the 3D representation, the virtual camera constrained to have only the particular orientations, the particular orientations less than an entirety of all orientations.

In some aspects, the techniques described herein relate to one or more non-transitory computer-readable media wherein positions, orientations, or positions and orientations in the 3D representation have quality attributes, and identifying the particular regions in the 3D representation in which the virtual camera may move and the particular orientations that the virtual camera may have includes identifying, based on the quality attributes, the particular regions having particular positions, orientations, or positions and orientations having quality attributes above a threshold.

In some aspects, the techniques described herein relate to one or more non-transitory computer-readable media, the method further including determining positions of the aerial drone in the environment at which the aerial drone captured the images, wherein identifying the particular regions in the 3D representation in which the virtual camera may move as the 3D representation is navigated includes identifying, based on the positions of the aerial drone in the environment at which the aerial drone captured the images, the particular regions in the 3D representation in which the virtual camera may move as the 3D representation is navigated.

In some aspects, the techniques described herein relate to one or more non-transitory computer-readable media, the method further including determining one or more central positions of the 3D representation, wherein identifying the particular regions in the 3D representation in which the virtual camera may move as the 3D representation is navigated includes identifying, based on the one or more central positions of the 3D representation, the particular regions in the 3D representation in which the virtual camera may move as the 3D representation is navigated.

In some aspects, the techniques described herein relate to one or more non-transitory computer-readable media wherein the 3D representation includes a building 3D representation of the building, and the building 3D representation is located at a central position of the 3D representation.

In some aspects, the techniques described herein relate to one or more non-transitory computer-readable media wherein receiving the inputs to navigate the 3D representation by moving the virtual camera in the 3D representation includes receiving first inputs to move the virtual camera along a first path of a first type in the 3D representation and receiving second inputs to move the virtual camera along a second path of a second type, the second type different from the first type, in the 3D representation.

In some aspects, the techniques described herein relate to one or more non-transitory computer-readable media wherein the first inputs are in or along a horizontal axis of an input device and the second inputs are in or along a vertical axis of the input device.

In some aspects, the techniques described herein relate to one or more non-transitory computer-readable media, the method further including: moving, based on the first inputs, the virtual camera along a generally circular path around a vertical axis of the 3D representation at a generally constant altitude in the 3D representation, the vertical axis located at a central position of the 3D representation; and aiming a yaw of the virtual camera at the central position of the 3D representation.

In some aspects, the techniques described herein relate to one or more non-transitory computer-readable media, the method further including changing, based on the second inputs, one or more of an altitude of the virtual camera in the 3D representation, a distance of the virtual camera from a central position of the 3D representation, a pitch of the virtual camera, and a field of view of the virtual camera.

In some aspects, the techniques described herein relate to a method including: receiving images of an environment, the environment including a building, the images captured by an aerial drone; generating, based on the images, a 3D representation of the environment, the 3D representation including Gaussian splats representing the environment, including the building; identifying particular regions in the 3D representation in which a virtual camera for viewing the 3D representation may be positioned as the 3D representation is navigated, the virtual camera constrained to be positioned only in the particular regions, the particular regions less than an entirety of the 3D representation; providing the 3D representation for display; receiving inputs to navigate the 3D representation by positioning the virtual camera in the 3D representation; and positioning, based on the inputs, the virtual camera only in the particular regions in the 3D representation.

In some aspects, the techniques described herein relate to a method, further including identifying particular orientations that the virtual camera may have as the virtual camera moves in the particular regions in the 3D representation, the virtual camera constrained to have only the particular orientations, the particular orientations less than an entirety of all orientations.

In some aspects, the techniques described herein relate to a method wherein positions, orientations, or positions and orientations in the 3D representation have quality attributes, and identifying the particular regions in the 3D representation in which the virtual camera may move and the particular orientations that the virtual camera may have includes identifying, based on the quality attributes, the particular regions having particular positions, orientations, or positions and orientations having quality attributes above a threshold.

In some aspects, the techniques described herein relate to a method, further including determining positions of the aerial drone in the environment at which the aerial drone captured the images, wherein identifying the particular regions in the 3D representation in which the virtual camera may move as the 3D representation is navigated includes identifying, based on the positions of the aerial drone in the environment at which the aerial drone captured the images, the particular regions in the 3D representation in which the virtual camera may move as the 3D representation is navigated.

In some aspects, the techniques described herein relate to a method, further including determining one or more central positions of the 3D representation, wherein identifying the particular regions in the 3D representation in which the virtual camera may move as the 3D representation is navigated includes identifying, based on the one or more central positions of the 3D representation, the particular regions in the 3D representation in which the virtual camera may move as the 3D representation is navigated.

In some aspects, the techniques described herein relate to a method wherein the 3D representation includes a building 3D representation of the building, and the building 3D representation is located at a central position of the 3D representation.

In some aspects, the techniques described herein relate to a method wherein receiving the inputs to navigate the 3D representation by moving the virtual camera in the 3D representation includes receiving first inputs to move the virtual camera along a first path of a first type in the 3D representation and receiving second inputs to move the virtual camera along a second path of a second type, the second type different from the first type, in the 3D representation.

In some aspects, the techniques described herein relate to a method wherein the first inputs are in or along a horizontal axis of an input device and the second inputs are in or along a vertical axis of the input device.

In some aspects, the techniques described herein relate to a method, further including: moving, based on the first inputs, the virtual camera along a generally circular path around a vertical axis of the 3D representation at a generally constant altitude in the 3D representation, the vertical axis located at a central position of the 3D representation; and aiming a yaw of the virtual camera at the central position of the 3D representation.

In some aspects, the techniques described herein relate to a method, further including changing, based on the second inputs, one or more of an altitude of the virtual camera in the 3D representation, a distance of the virtual camera from a central position of the 3D representation, a pitch of the virtual camera, and a field of view of the virtual camera.

In some aspects, the techniques described herein relate to a method wherein positioning, based on the inputs, the virtual camera only in the particular regions in the 3D representation includes moving, based on the inputs, the virtual camera only in the particular regions in the 3D representation.

In some aspects, the techniques described herein relate to a method wherein positioning, based on the inputs, the virtual camera only in the particular regions in the 3D representation includes moving, based on the inputs, the 3D representation relative to the virtual camera.

In some aspects, the techniques described herein relate to a system including at least one processor and at least one memory including executable instructions that when executed by the at least one processor cause the system to: receive images of an environment, the environment including a building, the images captured by an aerial drone; generate, based on the images, a 3D representation of the environment, the 3D representation including Gaussian splats representing the environment, including the building; identify particular regions in the 3D representation in which a virtual camera for viewing the 3D representation may be positioned as the 3D representation is navigated, the virtual camera constrained to be positioned only in the particular regions, the particular regions less than an entirety of the 3D representation; provide the 3D representation for display; receive inputs to navigate the 3D representation by positioning the virtual camera in the 3D representation; and position, based on the inputs, the virtual camera only in the particular regions in the 3D representation.

In some aspects, the techniques described herein relate to one or more non-transitory computer-readable media including executable instructions, the executable instructions being executable by one or more processors to perform a method, the method including: receiving images of an environment captured by an aerial drone, the environment including a building having an interior; generating, based on the images, an environment 3D representation, the environment 3D representation utilizing Gaussian splats to represent the environment, including at least some of the building; receiving 360 degree panoramic images of at least some of the building, at least some of the 360 degree panoramic images including at least some of the interior of the building; generating, based on the 360 degree panoramic images, a building representation, the building representation representing at least some of the building, including at least some of the interior of the building; providing the environment 3D representation for display; and providing the building representation for display.

In some aspects, the techniques described herein relate to one or more non-transitory computer-readable media, the method further including: receiving first inputs to navigate the environment 3D representation by moving a first virtual camera for viewing the environment 3D representation in the environment 3D representation; moving, based on the first inputs, the first virtual camera in the environment 3D representation; receiving second inputs to navigate the building representation by moving a second virtual camera for viewing the building representation in the building representation; and moving, based on the second inputs, the second virtual camera in the building representation.

In some aspects, the techniques described herein relate to one or more non-transitory computer-readable media wherein the environment 3D representation and the building representation are not displayed concurrently, and the method further including: while displaying one of the environment 3D representation and the building representation, receiving a third input to select the other of the environment 3D representation and the building representation for display; and displaying the other of the environment 3D representation and the building representation.

In some aspects, the techniques described herein relate to one or more non-transitory computer-readable media wherein receiving the third input to select the other of the environment 3D representation and the building representation for display includes receiving a selection of one of an environment user interface element for requesting that the environment 3D representation be displayed and a building user interface element for requesting that the building representation be displayed.

In some aspects, the techniques described herein relate to one or more non-transitory computer-readable media wherein receiving the third input to select the other of the environment 3D representation and the building representation for display includes receiving an input to move one of the first virtual camera towards the building representation and the second virtual camera towards the environment 3D representation.

In some aspects, the techniques described herein relate to one or more non-transitory computer-readable media, the method further including transitioning from displaying the environment 3D representation from a first perspective of the first virtual camera to displaying the building representation from a second perspective of the second virtual camera or from displaying the building representation from the second perspective of the second virtual camera to displaying the environment 3D representation from the first perspective of the first virtual camera.

In some aspects, the techniques described herein relate to one or more non-transitory computer-readable media wherein the 360 degree panoramic images are associated with capture locations in the environment, including in the interior of the building, the building representation includes waypoints corresponding to the capture locations at which the 360 degree panoramic images may be displayed, and at least one first waypoint and at least one second waypoint are linked such that the at least one first waypoint and the at least one second waypoint may be navigated between.

In some aspects, the techniques described herein relate to one or more non-transitory computer-readable media, the method further including aligning the environment 3D representation with the building representation.

In some aspects, the techniques described herein relate to a method including: receiving images of an environment captured by an aerial drone, the environment including a building having an interior; generating, based on the images, an environment 3D representation, the environment 3D representation utilizing Gaussian splats to represent the environment, including at least some of the building; receiving 360 degree panoramic images of at least some of the building, at least some of the 360 degree panoramic images including at least some of the interior of the building; generating, based on the 360 degree panoramic images, a building representation, the building representation representing at least some of the building, including at least some of the interior of the building; providing the environment 3D representation for display; and providing the building representation for display.

In some aspects, the techniques described herein relate to a method, further including: receiving first inputs to navigate the environment 3D representation by moving a first virtual camera for viewing the environment 3D representation in the environment 3D representation; moving, based on the first inputs, the first virtual camera in the environment 3D representation; receiving second inputs to navigate the building representation by moving a second virtual camera for viewing the building representation in the building representation; and moving, based on the second inputs, the second virtual camera in the building representation.

In some aspects, the techniques described herein relate to a method wherein the environment 3D representation and the building representation are not displayed concurrently, and further including: while displaying one of the environment 3D representation and the building representation, receiving a third input to select the other of the environment 3D representation and the building representation for display; and displaying the other of the environment 3D representation and the building representation.

In some aspects, the techniques described herein relate to a method wherein receiving the third input to select the other of the environment 3D representation and the building representation for display includes receiving a selection of one of an environment user interface element for requesting that the environment 3D representation be displayed and a building user interface element for requesting that the building representation be displayed.

In some aspects, the techniques described herein relate to a method wherein receiving the third input to select the other of the environment 3D representation and the building representation for display includes receiving an input to move one of the first virtual camera towards the building representation and the second virtual camera towards the environment 3D representation.

In some aspects, the techniques described herein relate to a method, further including transitioning from displaying the environment 3D representation from a first perspective of the first virtual camera to displaying the building representation from a second perspective of the second virtual camera or from displaying the building representation from the second perspective of the second virtual camera to displaying the environment 3D representation from the first perspective of the first virtual camera.

In some aspects, the techniques described herein relate to a method wherein the 360 degree panoramic images are associated with capture locations in the environment, including in the interior of the building, the building representation includes waypoints corresponding to the capture locations at which the 360 degree panoramic images may be displayed, and at least one first waypoint and at least one second waypoint are linked such that the at least one first waypoint and the at least one second waypoint may be navigated between.

In some aspects, the techniques described herein relate to a method, further including aligning the environment 3D representation with the building representation.

In some aspects, the techniques described herein relate to a system including at least one processor and at least one memory including executable instructions that when executed by the at least one processor cause the system to: receiving images of an environment captured by an aerial drone, the environment including a building having an interior; generating, based on the images, an environment 3D representation, the environment 3D representation utilizing Gaussian splats to represent the environment, including at least some of the building; receiving 360 degree panoramic images of at least some of the building, at least some of the 360 degree panoramic images including at least some of the interior of the building; generating, based on the 360 degree panoramic images, a building representation, the building representation representing at least some of the building, including at least some of the interior of the building; providing the environment 3D representation for display; and providing the building representation for display.

In some aspects, the techniques described herein relate to one or more non-transitory computer-readable media including executable instructions, the executable instructions being executable by one or more processors to perform a method, the method including: receiving a first 3D representation, the first 3D representation representing an environment, the environment including a building having an exterior portion and an interior portion, the first 3D representation representing the exterior portion of the building, the first 3D representation having a first type; receiving a first location for the first 3D representation; receiving a second 3D representation, the second 3D representation representing the interior portion of the building, the second 3D representation having a second type different from the first type of the first 3D representation; receiving a second location for the second 3D representation; aligning, based on the first location and the second location, the first 3D representation with the second 3D representation; and providing the first 3D representation aligned with the second 3D representation for display.

In some aspects, the techniques described herein relate to one or more non-transitory computer-readable media, the method further including: receiving multiple third locations associated with the first 3D representation; determining, based on the multiple third locations, the first location for the first 3D representation; receiving multiple fourth locations associated with the second 3D representation; and determining, based on the multiple fourth locations, the second location for the first 3D representation.

In some aspects, the techniques described herein relate to one or more non-transitory computer-readable media wherein the multiple third locations include multiple GPS locations, and determining, based on the multiple third locations, the first location for the first 3D representation includes applying a fitting algorithm to the multiple GPS locations to determine the first location.

In some aspects, the techniques described herein relate to one or more non-transitory computer-readable media, the method further including: receiving a first altitude for the first 3D representation; and receiving a second altitude for the second 3D representation, wherein aligning the first 3D representation with the second 3D representation is further based on the first altitude and the second altitude.

In some aspects, the techniques described herein relate to one or more non-transitory computer-readable media wherein the environment further includes the ground, the first 3D representation further representing a first portion of the ground, the second 3D representation further representing a second portion of the ground, and the method further including: determining, based on the first portion of the ground, the first altitude; and determining, based on the second portion of the ground, the second altitude.

In some aspects, the techniques described herein relate to one or more non-transitory computer-readable media wherein the environment includes the ground, the first 3D representation further representing a portion of the ground, the building includes one or more stories, and the method further including: determining, based on the portion of the ground, the first altitude; determining a lowest story of the one or more stories; and determining, based on the first altitude and the lowest story, the second altitude.

In some aspects, the techniques described herein relate to one or more non-transitory computer-readable media, the method further including: determining the first altitude; applying a fitting algorithm to fit at least a first portion of the first 3D representation to at least a second portion of the second 3D representation; and determining, based on the first altitude and applying the fitting algorithm, the second altitude.

In some aspects, the techniques described herein relate to one or more non-transitory computer-readable media, the method further including: identifying first geometric features of the first 3D representation and second geometric features of the second 3D representation that correspond to the first geometric features; and realigning, based on the first geometric features and the second geometric features, the first 3D representation with the second 3D representation.

In some aspects, the techniques described herein relate to one or more non-transitory computer-readable media, the method further including: receiving building data for the second 3D representation, the building data including one or more boundaries of the building; determining, based on the second 3D representation, the building data, or both the second 3D representation and the building data, an exterior shape of the building; and realigning, based on the exterior portion of the building represented by the first 3D representation and the exterior shape of the building, the first 3D representation with the second 3D representation.

In some aspects, the techniques described herein relate to one or more non-transitory computer-readable media or, the method further including, after realigning: displaying the first 3D representation and the second 3D representation; receiving one or more inputs for realigning the first 3D representation with the second 3D representation; and realigning, based on the one or more inputs, the first 3D representation with the second 3D representation.

In some aspects, the techniques described herein relate to one or more non-transitory computer-readable media wherein receiving the one or more inputs includes receiving a first input selecting a first portion of the first 3D representation and receiving a second input selecting a second portion of the second 3D representation and realigning, based on the one or more inputs, the first 3D representation with the second 3D representation includes realigning, based on the first portion of the first 3D representation and the second portion of the second 3D representation, the first 3D representation with the second 3D representation.

In some aspects, the techniques described herein relate to a method including: receiving a first 3D representation, the first 3D representation representing an environment, the environment including a building having an exterior portion and an interior portion, the first 3D representation representing the exterior portion of the building, the first 3D representation having a first type; receiving a second 3D representation, the second 3D representation representing the interior portion of the building, the second 3D representation having a second type different from the first type of the first 3D representation; aligning the first 3D representation with the second 3D representation; and providing the first 3D representation aligned with the second 3D representation for display.

In some aspects, the techniques described herein relate to a method, further including: receiving a first location for the first 3D representation; and receiving a second location for the second 3D representation, wherein aligning the first 3D representation with the second 3D representation includes aligning, based on the first location and the second location, the first 3D representation with the second 3D representation.

In some aspects, the techniques described herein relate to a method, further including: receiving multiple third locations associated with the first 3D representation; determining, based on the multiple third locations, the first location for the first 3D representation; receiving multiple fourth locations associated with the second 3D representation; and determining, based on the multiple fourth locations, the second location for the first 3D representation.

In some aspects, the techniques described herein relate to a method wherein the multiple third locations include multiple GPS locations, and determining, based on the multiple third locations, the first location for the first 3D representation includes applying a fitting algorithm to the multiple GPS locations to determine the first location.

In some aspects, the techniques described herein relate to a method, further including: receiving a first altitude for the first 3D representation; and receiving a second altitude for the second 3D representation, wherein aligning the first 3D representation with the second 3D representation is further based on the first altitude and the second altitude.

In some aspects, the techniques described herein relate to a method wherein the environment further represents the ground, the first 3D representation further represents a first portion of the ground, the second 3D representation further represents a second portion of the ground, and the method further including: determining, based on the first portion of the ground, the first altitude; and determining, based on the second portion of the ground, the second altitude.

In some aspects, the techniques described herein relate to a method wherein the environment includes the ground, the first 3D representation further represents a portion of the ground, the building includes one or more stories, and the method further including: determining, based on the portion of the ground, the first altitude; determining a lowest story of the one or more stories; and determining, based on the first altitude and the lowest story, the second altitude.

In some aspects, the techniques described herein relate to a method, further including: determining the first altitude; applying a fitting algorithm to fit at least a first portion of the first 3D representation to at least a second portion of the second 3D representation; and determining, based on the first altitude and applying the fitting algorithm, the second altitude.

In some aspects, the techniques described herein relate to a method, further including: identifying first geometric features of the first 3D representation and second geometric features of the second 3D representation that correspond to the first geometric features; and realigning, based on the first geometric features and the second geometric features, the first 3D representation with the second 3D representation.

In some aspects, the techniques described herein relate to a method, further including: receiving building data for the second 3D representation, the building data including one or more boundaries of the building; determining, based on the second 3D representation, the building data, or both the second 3D representation and the building data, an exterior shape of the building; and realigning, based on the exterior portion of the building represented in the first 3D representation and the exterior shape of the building, the first 3D representation with the second 3D representation.

In some aspects, the techniques described herein relate to a method or, the method further including, after realigning: displaying the first 3D representation and the second 3D representation; receiving one or more inputs for realigning the first 3D representation with the second 3D representation; and realigning, based on the one or more inputs, the first 3D representation with the second 3D representation.

In some aspects, the techniques described herein relate to a method wherein receiving the one or more inputs includes receiving a first input selecting a first portion of the first 3D representation and receiving a second input selecting a second portion of the second 3D representation and realigning, based on the one or more inputs, the first 3D representation with the second 3D representation includes realigning, based on the first portion of the first 3D representation and the second portion of the second 3D representation, the first 3D representation with the second 3D representation.

In some aspects, the techniques described herein relate to a system including at least one processor and at least one memory including executable instructions that when executed by the at least one processor cause the system to: receive a first 3D representation, the first 3D representation representing an environment, the environment including a building having an exterior portion and an interior portion, the first 3D representation including the exterior portion of the building, the first 3D representation having a first type; receive a second 3D representation, the second 3D representation including the interior portion of the building, the second 3D representation having a second type different from the first type of the first 3D representation; align the first 3D representation with the second 3D representation; and provide the first 3D representation aligned with the second 3D representation for display.

In some aspects, the techniques described herein relate to one or more non-transitory computer-readable media including executable instructions, the executable instructions being executable by one or more processors to perform a method, the method including: receiving a first 3D representation, the first 3D representation representing an environment, the environment including a building having an exterior and an interior, the first 3D representation including Gaussian splats representing the environment, including at least some of the exterior of the building; receiving a second 3D representation, the second 3D representation representing at least some of the interior of the building, the first 3D representation and the second 3D representation aligned in a common 3D space; providing the first 3D representation and the second 3D representation for display; and displaying a first portion of the first 3D representation simultaneously with a second portion of the second 3D representation.

In some aspects, the techniques described herein relate to one or more non-transitory computer-readable media wherein the second 3D representation representing at least some of the interior of the building includes one or more of Gaussian splats, a 3D mesh, a wireframe, or a floor plan positioned and scaled in 3D.

In some aspects, the techniques described herein relate to one or more non-transitory computer-readable media wherein the second 3D representation further represents at least some of the exterior of the building and the second portion of the second 3D representation represents at least some of the interior of the building.

In some aspects, the techniques described herein relate to one or more non-transitory computer-readable media wherein the building includes one or more stories and the second portion of the second 3D representation represents at least one story of the one or more stories.

In some aspects, the techniques described herein relate to one or more non-transitory computer-readable media wherein the building includes one or more rooms and the second portion of the second 3D representation represents at least one room of the one or more rooms.

In some aspects, the techniques described herein relate to one or more non-transitory computer-readable media, the method further including: identifying the second portion of the second 3D representation for display; and identifying, based on the second portion, the first portion of the first 3D representation for display.

In some aspects, the techniques described herein relate to one or more non-transitory computer-readable media wherein the building includes a roof, exterior walls, one or more stories and one or more rooms on the one or more stories, identifying the second portion of the second 3D representation for display includes identifying at least one story of the one or more stories or at least one room of the one or more rooms, and identifying, based on the second portion, the first portion of the first 3D representation for display includes identifying, based on the at least one story or the at least one room, a first portion of the first 3D representation that excludes at least some of the roof or at least some of the exterior walls.

In some aspects, the techniques described herein relate to one or more non-transitory computer-readable media wherein displaying the first portion of the first 3D representation simultaneously with the second portion of the second 3D representation includes displaying the second portion of the second 3D representation that would otherwise be occluded by displaying the first portion of the first 3D representation.

In some aspects, the techniques described herein relate to one or more non-transitory computer-readable media wherein displaying the first portion of the first 3D representation simultaneously with the second portion of the second 3D representation includes displaying at least some of the first portion of the first 3D representation as partially transparent and at least some of the second portion of the second 3D representation as partially visible.

In some aspects, the techniques described herein relate to one or more non-transitory computer-readable media wherein the building includes one or more rooms, and the method further including: receiving building data, the building data including one or more of a floor plan of the building, one or more dimensions or one or more boundaries of the one or more rooms of the building, or one or more classifications of the one or more rooms of the building; providing the building data for display; and displaying at least some of the building data simultaneously with the first portion of the first 3D representation and the second portion of the second 3D representation.

In some aspects, the techniques described herein relate to one or more non-transitory computer-readable media wherein the one or more classifications of the one or more rooms of the building include one or more room labels of the one or more rooms.

In some aspects, the techniques described herein relate to a method including: receiving a first 3D representation, the first 3D representation representing an environment, the environment including a building having an exterior and an interior, the first 3D representation including Gaussian splats representing the environment, including at least some of the exterior of the building; receiving a second 3D representation, the second 3D representation representing at least some of the interior of the building, the first 3D representation and the second 3D representation aligned in a common 3D space; providing the first 3D representation and the second 3D representation for display; and displaying a first portion of the first 3D representation simultaneously with a second portion of the second 3D representation.

In some aspects, the techniques described herein relate to a method wherein the second 3D representation representing the interior of the building includes one or more of Gaussian splats, a 3D mesh, a wireframe, or a floor plan positioned and scaled in 3D.

In some aspects, the techniques described herein relate to a method wherein the second 3D representation further represents at least some of the exterior of the building and the second portion of the second 3D representation represents at least some of the interior of the building.

In some aspects, the techniques described herein relate to a method wherein the building includes one or more stories and the second portion of the second 3D representation represents at least one story of the one or more stories.

In some aspects, the techniques described herein relate to a method wherein the building includes one or more rooms and the second portion of the second 3D representation represents at least one room of the one or more rooms.

In some aspects, the techniques described herein relate to a method, further including: identifying the second portion of the second 3D representation for display; and identifying, based on the second portion, the first portion of the first 3D representation for display.

In some aspects, the techniques described herein relate to a method wherein the building includes a roof, exterior walls, one or more stories and one or more rooms on the one or more stories, identifying the second portion of the second 3D representation for display includes identifying at least one story of the one or more stories or at least one room of the one or more rooms, and identifying, based on the second portion, the first portion of the first 3D representation for display includes identifying, based on the at least one story or the at least one room, a first portion of the first 3D representation that excludes at least some of the roof or at least some of the exterior walls.

In some aspects, the techniques described herein relate to a method wherein displaying the first portion of the first 3D representation simultaneously with the second portion of the second 3D representation includes displaying the second portion of the second 3D representation that would otherwise be occluded by displaying the first portion of the first 3D representation.

In some aspects, the techniques described herein relate to a method wherein displaying the first portion of the first 3D representation simultaneously with the second portion of the second 3D representation includes displaying at least some of the first portion of the first 3D representation as partially transparent and at least some of the second portion of the second 3D representation as partially visible.

In some aspects, the techniques described herein relate to a method wherein the building includes one or more rooms, and further including: receiving building data, the building data including one or more of a floor plan of the building, one or more dimensions or one or more boundaries of the one or more rooms of the building, or one or more classifications of the one or more rooms of the building; providing the building data for display; and displaying at least some of the building data simultaneously with the first portion of the first 3D representation and the second portion of the second 3D representation.

In some aspects, the techniques described herein relate to a method wherein the one or more classifications of the one or more rooms of the building include one or more room labels of the one or more rooms.

In some aspects, the techniques described herein relate to a system including at least one processor and at least one memory including executable instructions that when executed by the at least one processor cause the system to: receive a first 3D representation, the first 3D representation representing an environment, the environment including a building having an exterior and an interior, the first 3D representation including Gaussian splats representing the environment, including at least some of the exterior of the building; receive a second 3D representation, the second 3D representation representing at least some of the interior of the building, the first 3D representation and the second 3D representation aligned in a common 3D space; provide the first 3D representation and the second 3D representation for display; and display a first portion of the first 3D representation simultaneously with a second portion of the second 3D representation.

### BRIEF DESCRIPTION OF THE DRAWINGS

FIG. 1 depicts an example environment in which a 3D representation system may operate in some embodiments.

FIG. 2A depicts an example capture system in the form of a 3D camera according to some embodiments.

FIG. 2B depicts another example capture system in the form of an aerial drone in some embodiments.

FIG. 3 is a block diagram depicting components of the 3D representation system according to some embodiments.

FIG. 4 is a flow diagram depicting a method for moving a virtual camera in a 3D representation in some embodiments.

FIG. 5 is a flow diagram depicting a method for generating a 3D representation of an environment and a 3D representation of a building according to some embodiments.

FIG. 6 is a flow diagram depicting a method for aligning two 3D representations having two different types in some embodiments.

FIG. 7 is a flow diagram depicting a method for displaying a 3D representation of an environment and a 3D representation of a building interior simultaneously according to some embodiments.

FIG. 8A to 8K depict 3D representations of an environment and of a building viewed from different perspectives of a virtual camera.

FIG. 9 depicts another 3D representation of a building along with building data.

FIG. 10 depicts a 3D representation of a room of a building and content for the room.

FIG. 11 depicts another 3D representation of a room in a building and content for the room.

FIG. 12 depicts another 3D representation of a building along with building data.

FIG. 13 depicts a 3D representation of an environment displayed simultaneously with another 3D representation of a building.

FIG. 14 depicts a 3D representation of a room of a building along with room items identified.

FIG. 15 depicts another 3D representation of a building along with building data.

FIGS. 16A to 16C depict a 3D representation of an environment and different 3D representations of rooms of a building along with building data.

FIG. 17 is a block diagram of an example digital device according to various embodiments.

Throughout the drawings, like reference numerals will be understood to refer to like parts, components, and structures.

### DETAILED DESCRIPTION

Described herein is a 3D representation system for generating and presenting 3D and other representations and associated data. The 3D representation system may also allow for switching between different presentation modes of 3D (and optionally two-dimensional (2D)) content and navigating in 3D representations. An example 3D representation system may also capture, create, or process content in order to prepare the content for such 3D and other representations and associated data.

Examples of this type of multi-mode presentation include the Matterport Showcase viewer switching between dollhouse, floor plan, and inside modes as well as Google Earth switching between 3D and Street View modes. Various embodiments described herein may include more presentation modes, more ways of combining and switching between them, or more ways of capturing, creating, or preparing the necessary content.

It will be appreciated that the creation of a 3D representation representing a real-world environment (for example, a building, house, factory, and the like) may involve processing images (for example, 2D images) captured by one or more image capture systems (for example, cameras). In various embodiments, depth information may also be captured to assist in the creation of the 3D representation. The 3D representation may be navigated in various ways to give a user a sense of the real environment that the 3D representation represents. In one example, a digital device such as a computer, mobile phone, or the like may render a 3D representation of an environment to enable a user to view all or part of the 3D representation, such as through and by switching among the different presentation modes.

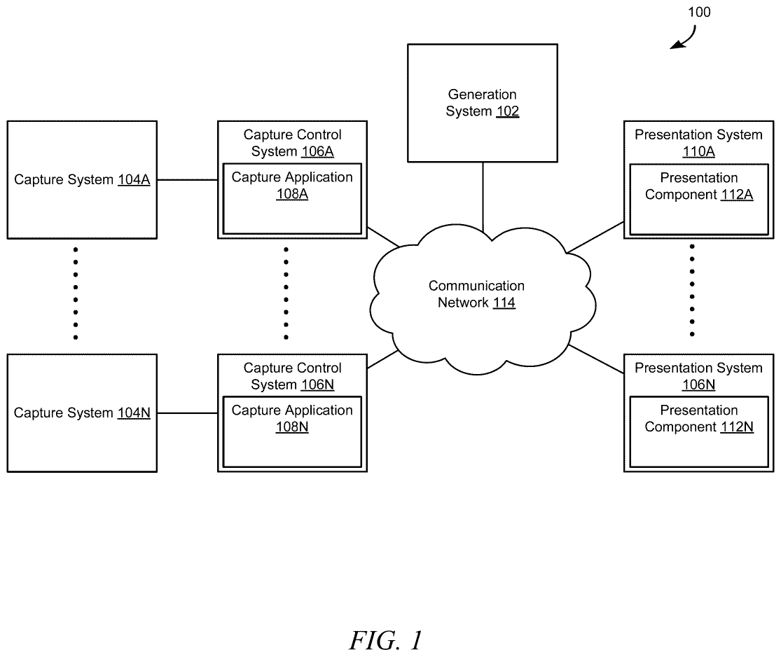

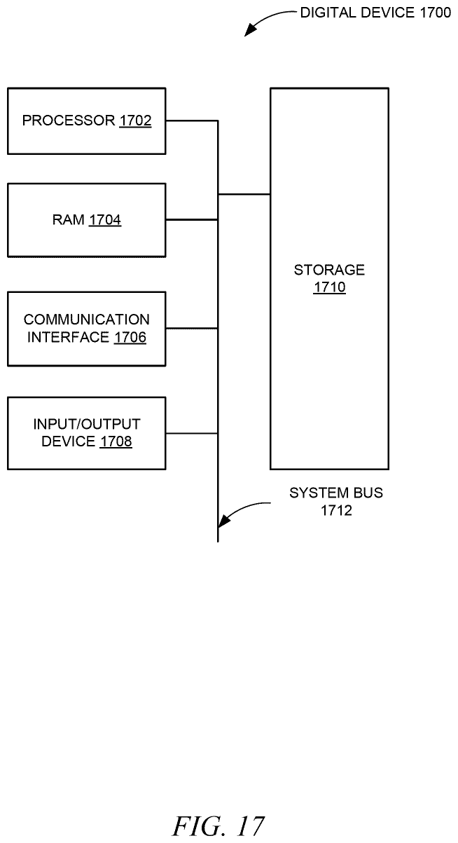

FIG. 1 depicts an example environment 100 in which a 3D representation system may operate according to some embodiments. The environment 100 includes multiple capture systems 104A through 104N (which may be referred to as a capture system 104 or as capture systems 104), multiple capture control systems 106A through 106N (which may be referred to as a capture control system 106 or as capture control systems 106), a generation system 102, multiple presentation systems 110A through 110N (which may be referred to as a presentation system 110 or as presentation systems 110), and a communication network 114. Each of the capture systems 104, the capture control systems 106, the generation system 102, and the presentation systems 110 may be or include any number of digital devices. A digital device is any device with at least one processor and memory. Digital devices are discussed further herein, for example, with reference to FIG. 17.

The capture systems 104 may each be or include a system that is configured to capture images, video or 3D data of physical environments, such as buildings (for example, houses or office buildings), other structures, or outdoor environments. For example, the capture systems 104 may have scanning functionality to capture 3D data (for example, using a laser imaging, detection, and ranging device (LiDAR)) and imaging functionality to capture images or video (for example, using imaging sensors). The capture systems 104 may also capture other sensor data, such as Global Positioning Service (GPS) or A-GPS data or other location data. Examples of capture systems 104 are 3D cameras such as the Matterport Pro 3 camera, 360-degree cameras such as the Ricoh Theta series of 360-degree cameras, mobile phones or tablets such as iOS operating system phones or tablets and Android operating system phones or tablets, and aerial drones. The capture systems 104 are not limited to the examples described herein.

The capture control systems 106 may each be or include a system that includes a capture application 108 (shown individually as capture applications 108A through 108N) that is configured to control the capture of the images, video, 3D data, or other sensor data by the capture systems 104. The capture applications 108 may also capture other sensor data, such as GPS or A-GPS data or other location data. Examples of capture control systems 106 are mobile phones or tablets such as iOS operating system phones or tablets and Android operating system phones or tablets. One example of a capture application is the Matterport application for iOS or Android. The capture control systems 106 are not limited to the examples described herein. Similarly, the capture applications 108 are not limited to the example described herein.

The capture systems 104 may provide the captured images, video, 3D data, or other sensor data (which may be referred to individually or in a group as captured data, captured content, content, or data) to the capture applications 108. The capture systems 104 may provide the captured data to the capture applications 108 via a Wi-Fi connection, a Bluetooth Low Energy (BLE) connection, or a wired connection with the capture control systems 106. The capture applications 108 may process the captured data.

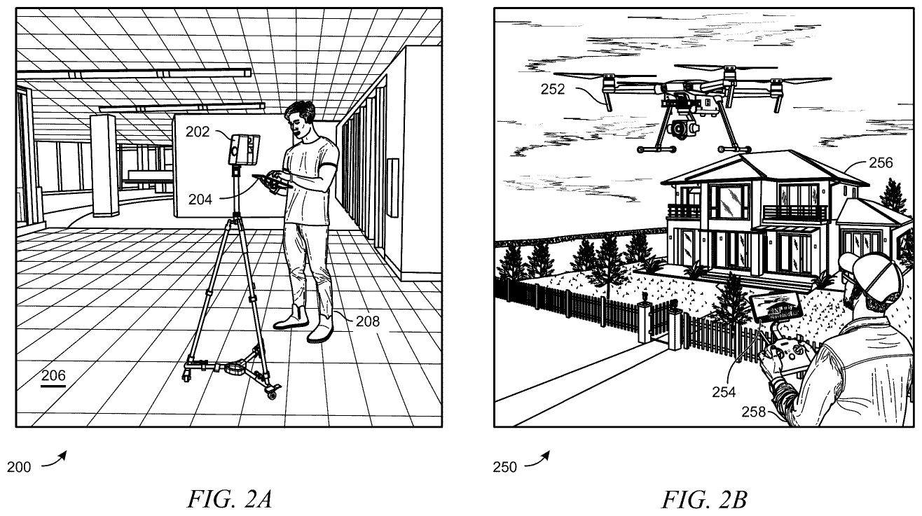

FIG. 2A depicts an example capture system 104 in the form of a 3D camera 202 and an example capture control system 106 in the form of a mobile tablet 204 according to some embodiments. A user 208 may utilize a capture application 108 (not illustrated in FIG. 2A) that the mobile tablet 204 may execute to control the 3D camera 202 to capture images, video, 3D data, or other sensor data of the environment 200, which includes a building 206. FIG. 2B depicts another example capture system 104 in the form of an aerial drone 252 and another example capture control system 106 in the form of a mobile phone 254 in some embodiments. A user 258 may utilize a capture application 108 (not illustrated in FIG. 2B) that the mobile phone 254 may execute to control the aerial drone 252 to capture images, video, 3D data, or other sensor data of the environment 250, which includes a building 256.

Other examples of capture systems 104 are a mobile robot carrying a camera that may be utilized to continuously capture data, a 360 camera carried by a human, such as on a pole, and cameras or other sensors placed at multiple locations and capturing data at each location. In some embodiments, the functionality or features of the capture application 108 or the capture control system 106 are included in the capture system 104.

Returning to FIG. 1, the capture applications 108 may provide the captured data to the generation system 102. The generation system 102 may be or include a system that is configured to receive the captured data and process the captured data. As described in more detail herein, the generation system 102 may also utilize the captured data to generate 3D representations and other data.

The generation system 102 may provide 3D representations to the presentation systems 110. The presentation systems 110 may each be or include a system that includes a presentation component 112 (shown individually as presentation components 112A through 112N) that is configured to display 3D representations (for example, using one or more display devices) and allow for navigation and exploration of 3D representations. Examples of presentation systems 110 are mobile phones or tablets, desktop or laptop computing devices, virtual or augmented reality devices, and televisions. One example of a presentation component is the Matterport 3D Showcase interactive web player that may be included in a web browser that may execute on a desktop or laptop computing device or on a mobile phone or tablet. In some embodiments, the capture applications 108 include the presentation components 112 or equivalent functionality. For example, the Matterport application may display 3D representations and allow for navigation and exploration of 3D representations.

The capture application 108, the generation system 102, and the presentation component 112 (individually or in a group) may be referred to herein as a 3D representation system. Accordingly, the 3D representation system may be interpreted as comprising any of the capture application 108, the generation system 102, or the presentation component 112. Similarly, functionality described as performed by the 3D representation system may be performed by any of the capture application 108, the generation system 102, or the presentation component 112.

In some embodiments, the communication network 114 may represent one or more computer networks (for example, local area networks (LANs), wide area networks (WANs), or the like). The communication network 114 may provide or facilitate communication between any of the generation system 102, the capture systems 104, the capture control systems 106, and the presentation systems 110. In some implementations, the communication network 114 comprises computer devices, routers, cables, or other network topologies. In some embodiments, the communication network 114 may be wired or wireless. In various embodiments, the communication network 114 may comprise the Internet, one or more networks that may be public, private, IP-based, non-IP based, and so forth.

Although the environment 100 depicted FIG. 1 has a specific configuration and the corresponding description relates specific functionality and features, it is to be understood that variations of the configuration depicted, or the functionality and features described are possible. For example, a capture system 104 may include control interfaces that a user may utilize to control the capture system 104 to capture data and the capture system 104 may provide the captured data to the generation system 102 without providing it to a capture application 108. As another example, there may be multiple generation systems 102. As another example, the generation system 102 may provide 3D representations to other systems not in the environment 100 (for example, computing systems of real-estate listing websites or other property information websites) for display. Accordingly, the disclosure is not limited to the description herein.

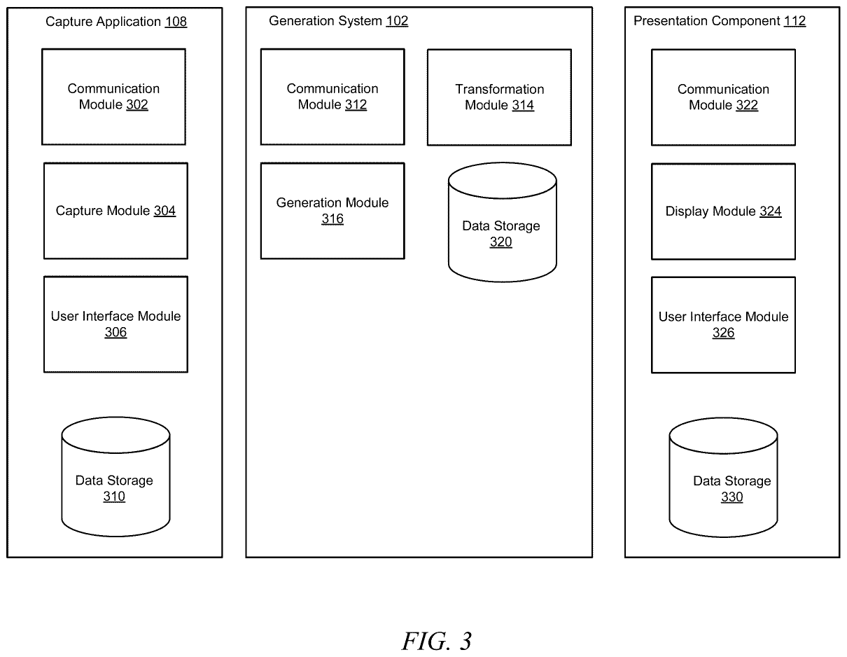

FIG. 3 is a block diagram depicting components of the capture application 108, components of the generation system 102, and components of the presentation component 112 according to some embodiments. The capture application 108 may include a communication module 302, a capture module 304, a user interface module 306, and a data storage 310. The generation system 102 may include a communication module 312, a transformation module 314, a generation module 316, and a data storage 320. The presentation component 112 may include a communication module 322, a display module 324, a user interface module 326, and a data storage 330.

The communication module 302 of the capture application 108 may send requests or data between the capture application 108 and any of the capture system 104, the generation system 102, and the presentation system 110. The communication module 312 of the generation system 102 and the communication module 322 of the presentation component 112 may perform similar functionality for the generation system 102 and the presentation system 110, respectively.

The capture module 304 of the capture application 108 may control the capture system 104 to capture images, video or 3D data of physical environments. The user interface module 306 of the capture application 108 may provide user interfaces for users to utilize to control the capture control systems 106.

The transformation module 314 of the generation system 102 may transform or reconstruct captured data or other data. The generation module 316 of the generation system 102 may generate 3D representations and other data.

The display module 324 of the presentation component 112 may display 3D representations and other data. The user interface module 326 of the presentation component 112 may provide user interfaces for users to utilize to navigate 3D representations.

The data storage 310 may include data stored, accessed, or modified by any of the modules of the capture application 108, the data storage 320 may include data stored, accessed, or modified by any of the modules of the generation system 102, and the data storage 330 may include data stored, accessed, or modified by any of the modules of the presentation component 112. The data storage 310, the data storage 320, or the data storage 330 may include any number of data storage structures such as tables, databases, lists, or the like. The data storage 310, the data storage 320, or the data storage 330 may include data that is stored in memory (for example, random access memory (RAM)), on disk or on solid-state devices, or some combination of in-memory and on-disk or on solid-state devices.

A module of the capture application 108, of the generation system 102 or of the presentation component 112 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in random access memory (RAM) or read-only memory (ROM), or any combination. Software may be executed by one or more processors. Although a limited number of modules are depicted in FIG. 3, there may be any number of modules. Further, individual modules may perform any number of functions, including functions of multiple modules as described herein.

### Content

The types of content that the 3D representation system may utilize may include any of the following, alone or in combination: 2D images or video; 3D meshes or other 3D surface representations; spatial data, including map data; point clouds or other 3D clouds; radiance fields or other neural representations; and voxel or other volumetric or solid representations, such as constructive solid geometry (CSG) representations.

2D images or video may be or include flat images, fisheye, panoramic, or other projections. The 2D images or video may include or have associated metadata such as camera or image position, orientation, or intrinsics to enable positioning or projection of the 2D content in 3D.

3D meshes or other 3D surface representations may be textured or untextured, optionally including view-dependent texturing. 3D meshes or other 3D surface representations may include surface properties such as normal maps or other information, may include multiple scales or levels of detail, or may include wireframes or other stylized rendering techniques.

Spatial data may include map data. Map data may include information about the locations or properties of objects, locations, or regions. Map data may also include data for streets, buildings, terrain types or features, points of interest, planned routes, or the like. Spatial data may be presented as 2D (for example icons) or 3D (for example, meshes, 3D lines, or other 3D shapes). Spatial data may also include auxiliary or derived data such as bounding boxes or preview panes with additional content such as text, images, or video. Spatial data may also have associated non-spatial data with spatial tagging or associations, such as temperature data with a known sensor location.

Point clouds or other 3D clouds may include clouds where each element has a more complex representation than a point, such as surfel clouds or Gaussian splats. Point clouds or other 3D clouds may include color, transparency, orientation, size, or other properties for each element.

Radiance fields or other neural representations may include direct (for example rendering each pixel using a NeRF) or derived or simplified (for example, a mesh with MLP-based textures) representations.

Any of the types of content described herein may be dynamic. Examples of dynamic content are live or updated data such as traffic data for maps, data from Internet of Things (IoT) devices, 2D or 3D data updated using sensors viewing the space such as video cameras, or content that is inherently variable or parameterized such as an animated 3D mesh. Additionally or alternatively, the content may be updated or edited by a user viewing the content or by other persons or systems.

### Capturing, Creating, or Processing Content

The 3D representation system may capture or facilitate capture of content in various ways. For example, the 3D representation system may receive raw or processed data from the capture systems 104 or the capture applications 108. Data may be collected from onboard sensors such as an RGB camera, an inertial measurement unit (IMU), a LiDAR or other depth sensor, or the like. The 3D representation system may also connect to other devices such as cameras or 3D scanners and receive data from them. The 3D representation system may also receive files or data already captured and possibly processed by other systems, such as images, video, spatial data, point clouds, meshes, or any of the other content types mentioned above.

The 3D representation system may manage or guide a capture process. For example, the 3D representation system may operate or provide guidance to an autonomous capture system such as an aerial drone or a mobile robot equipped with sensors. The 3D representation system may determine which sensors or systems to use during capture, and optionally during which parts of the capture process. The 3D representation system may also determine or apply sensor settings such as camera exposure, image resolution, image quality, scan density, sensor field of view, sensor aim, or the like.

The 3D representation system may also provide guidance to a user controlling or operating a capture system 104. Such guidance may include suggesting where the user should capture next, providing a plan or path for the user to follow (or have the capture system 104 follow), creating a visualization or otherwise communicating to the user what has already been captured, optionally including quality, density, or other information about what has been captured so far, or detecting failures or quality issues in capture and alerting the user or making that information available to the user.

The 3D representation system may transform or reconstruct captured data. For example, the 3D representation system may perform resizing, compressing, transcoding, cropping, or applying other basic transformations of the captured data. The 3D representation system may also simplify or create multiple levels of detail for data, such as creating multiple versions of a 3D mesh with different numbers of triangles or texture resolutions, creating subsampled point clouds, or the like.

The 3D representation system may process data to improve quality or appearance such as by applying higher-resolution algorithms, removing outlier data from point clouds or meshes, increasing image sharpness or contrast, processing neural radiance fields or Gaussian splats to remove floaters, or the like.

The 3D representation system may combine multiple inputs to reconstruct new data, such as by combining multiple 2D images to create a 3D point cloud or 3D mesh using photogrammetry, combining multiple images or depth images to train a Gaussian splat representation, combining a 3D mesh and images to create a textured 3D mesh, or the like. The 3D representation system may also project 2D content into or onto 3D, including projection onto a flat 3D surface or onto other 3D structures such as 3D point clouds or 3D meshes.

The 3D representation system may generate derived data or metadata. For example, the 3D representation system may determine metadata relevant to navigation or interaction during presentation. This metadata may include visibility, connectivity, or pathing within or between content elements. For example, if the content includes posed panoramas and a 3D mesh, the 3D representation system may determine which panoramas can be directly reached from each other panorama and which panoramas have obstructions such as walls between them, or determine how to generate a path between panoramas that avoids obstructions.

The 3D representation system may also determine presentation sequences such as virtual camera paths or transitions between content types. Virtual camera paths or transitions could be used as automatic presentation sequences without user input (for example automatic tours of a space) or interactively, in response to user input about a desired destination, what content the user would like to see, or the like.

The 3D representation system may determine points of interest, attractive or informative viewpoints, or other content elements for awareness or highlighting by the presentation component 112.

The 3D representation system may determine relationships between content elements. For example, the 3D representation system may determine relative poses or positions of content elements relative to each other, such as localizing the camera origin and orientation of a 2D image within a 3D mesh or point cloud, or aligning multiple 3D meshes or point clouds with each other. As another example, the 3D representation system may associate content with other content, such as by associating an IoT sensor with a room volume that encompasses the IoT sensor, or associating a tag or annotation of an object with the 3D mesh polygons or point cloud points that represent the object.

The 3D representation system may generate semantic understanding, scene understanding, or other data based on understanding the meaning or structure of the content.

Examples include: determining which parts of the content represent indoor vs. outdoor regions; and identifying or classifying objects or regions (such as rooms) represented within the content. This can include creating labels, searchable indexes, or the like for such identifications within the content. This can also include detecting the objects or regions before identifying or classifying them, segmenting or grouping portions of the content based on semantic class or other properties, including instance segmentation or general 2D or 3D segmentation, or determining regions (such as rooms, floors, or buildings) within the content and optionally defining boundaries for such regions. An example would be creating a schematic floor plan from a 3D mesh of a building, or creating a set of 3D volumes for the rooms.

The 3D representation system may modify or generate content. For example, the 3D representation system may generate new content associated with existing content, such as generating text based on the content (descriptions, stories, or the like) or new 2D or 3D content that extends or is based on the content. Examples include: generating content that complements the existing content, such as set(s) of furnishings that would virtually stage a property; filling in or completing missing portions of the content, such as 3D surfaces that were not observed during capture due to occlusions or limited field of view; or generating new content using the original content as input, such as generating images or 3D shapes using generative artificial intelligence (AI) and providing images, data, or other content as inputs to the generative networks. This generated content could be based on modified or generated content, instead of or in addition to the original content.

The 3D representation system may modify content or generate modified versions of the content. Examples include: creating views or alternate versions of the content with certain properties changed, such as visualizing what the content would look like at a different time of day, or with different colors, materials, or styles applied to it; generating versions of the content with spatial or structural changes, such as removing furnishings, changing the sizes or shapes of objects or rooms, adding another story to a build, or the like. Examples also include deleting or moving portions of the content, such as trimming away portions of a space, filtering or otherwise removing content or portions of content, or moving content or portions of content relative to each other, such as moving a piece of furniture or a building to another location.

Modification or generation of content may be based on direct user input (for example select an object and drag it to a new location), algorithms, or generative AI. For example, when algorithmic or using generative AI, the modification or generation of content may be user-guided or automated. Examples of automated approaches would be to always create a defurnished version of a space, to generate views of what the space would look like at certain times, or to generate a variety of sets of furnishings that could populate the space. Examples of user guidance would include user-entered text, image, or other prompts, a user select styles or colors from a menu, or a user be presented with generated option(s) and indicating which one(s) they prefer or dislike.

The 3D representation system may process or create content during pre-processing or may process or create content interactively as the content is being presented.

### Aligning 3D Representations

The 3D representation system may align 3D representations, including 3D representations of different types, so that the aligned 3D representations may be presented together. For example, the 3D representation system may align a Gaussian splat representation of an environment that includes a building with a 3D mesh representation of the building, such as the building interior. The 3D representation system may then display the two aligned 3D representations so that a user may navigate seamlessly between the two 3D representations. For example, the user may start by viewing the Gaussian splat representation of the environment.

The user may navigate in the Gaussian splat representation by moving a virtual camera in the Gaussian splat representation. The user may move the virtual camera towards the building to cause the 3D representation system to reveal a portion of the 3D mesh representation of the building interior. The user may then move the virtual camera into the building interior, and the 3D representation system may transition to displaying the 3D mesh representation of the building interior without displaying the Gaussian splat representation. Described herein are techniques for aligning 3D representations so that these and other interactions with aligned 3D representations are possible.

For a 3D representation that includes a 3D mesh, the 3D representation system may have many scan locations, each with a 3D position in the 3D mesh and also GPS data. The 3D representation system may determine an overall geolocation (for example, latitude, longitude, orientation) for the 3D mesh via a best-fit of the GPS data across the scan locations while maintaining their relative locations in the mesh. The 3D representation system may weight each scan location's GPS data more or less strongly based on GPS reliability data at that location. The 3D representation system may also use robust fitting methods such as discarding outliers. The 3D representation system may also include other location data beyond the GPS data (which may come from a capture system 104), such as location services data from the capture control system 106 or a user-entered location. Additional location information (accelerometer, magnetometer, barometer) may be used in determining the scan locations within the 3D mesh and could potentially be used for geolocation as well.

For a 3D representation that includes Gaussian splats, the 3D representation system may also have many photo locations, each with a 3D position relative to the Gaussian splats and GPS data. The 3D representation system may perform a similar process to find an overall geolocation of the splat representation. In some embodiments, the 3D representation system may receive an altitude that is captured by a capture system 104 such as an aerial drone. In some embodiments, the 3D representation system may have GPS data for each photo captured by the capture systems 104. Additionally or alternatively, the 3D representation system may receive geolocation attached to the processed Gaussian splat representation.

The 3D representation system may initialize the alignment between the 3D mesh and the Gaussian splats using the overall geolocation of each 3D representation. If the 3D representation system has the two locations relative to a common reference (geolocation relative to the earth), the 3D representation system may determine their location relative to each other. However, in some cases, the 3D representation system may not have altitude for the 3D mesh. When the 3D representation system does not have the altitude for the 3D mesh, the 3D representation system may perform an extra step to determine absolute or relative altitude. To do that, if the 3D mesh includes scans of the ground outside the building, the 3D representation system may locate the ground level separately in each representation and then choose an altitude for the 3D mesh that makes the 3D mesh ground level match the Gaussian splats ground level. If the 3D mesh doesn't include any of the ground outside the building, the 3D representation system may utilize heuristics such as setting the floor level of one of the building floors (the lowest, or the ground floor if the 3D representation system has information about which is the ground floor) equal to or with a standard offset from the exterior ground level detected in the Gaussian splats. The 3D representation system may also identify the general altitude of the building in the Gaussian splats and choose an altitude for the 3D mesh that fits within that exterior shape as accurately as possible.

These techniques may result in a good initial alignment between the Gaussian splats and 3D mesh, but the initial alignment may have certain deficiencies. To refine the initial alignment, the 3D representation system may utilize one or more of several techniques. One technique is to run an iterative closest point (ICP) algorithm or some other distance-minimization algorithm between corresponding geometric features of the Gaussian splat representation and the 3D mesh. In some cases, the 3D mesh may include scans of some outdoor areas (ground or building exterior). In such cases, the 3D representation system may find correspondences between those same surfaces in each 3D representation. The 3D representation system may align ground to ground, exterior walls to exterior walls, and so forth. Another approach that the 3D representation system may utilize relates to matching features that are expected to be identifiable on both the inside and outside of the building, such as doors and windows, though also potentially wall surfaces in general (accounting for wall thickness). The 3D representation system may identify the locations and shapes of doors and windows in both the interior 3D mesh and the exterior Gaussian splats. The 3D representation system may then propose an alignment based on finding correspondences between those features. One advantage of this technique is that doors and windows may also provide a tight match for altitude, so they could be used directly without requiring an altitude alignment step, or potentially even skipping an initial GPS initialization as long as the 3D representation system can identify the building of interest in the Gaussian splat representation.

To match corresponding features, the 3D representation system may filter each 3D representation to only the regions where the 3D representation system expects to have correspondences between the 3D representations. For example, the 3D representation system may filter out the 3D mesh corresponding to the inside of the building and filter out the Gaussian splats corresponding to the rest of the environment and only keep the portion of the Gaussian splats that represents the building. One way of doing this filtering would be via semantic segmentation, where the 3D representation system may assign semantic classes (grass, roof, door, etc.) to portions of each 3D representation and then align using this information. Additionally or alternatively, the 3D representation system may perform semantic segmentation where the 3D representation system only includes certain classes from each 3D representation. Additionally or alternatively, the 3D representation system may choose correspondences between the 3D representations that account for this semantic labeling, or the 3D representation system may use the semantic information internally to the alignment algorithm such as by weighting correspondences higher if they also have matching semantic classes.

Another option for refining the alignment (instead of or in addition to the above) is to use derived building data from the 3D mesh representation (and its associated data), such as room boundaries. If the 3D mesh only represents the interior of the building and the Gaussian splats only represent the exterior, the 3D representation system may infer an exterior shape of the building from the 3D mesh or room boundaries, including adjustment for the exterior wall thickness. The 3D representation system may then align the geometry of this extrapolated building exterior shape with the building exterior directly observed in the Gaussian splats. The 3D representation system may even solve for the potentially-unknown exterior wall thickness during this alignment.

In addition to these automatic alignment options, the 3D representation system may also generate or refine the alignment with the help of user input. The 3D representation system may show the two 3D representations together in a 3D viewer (composer) with a visualization that lets the user see how the two 3D representations are positioned relative to each other (for example with transparency so the user can see both versions at once). The user may then provide input about how to adjust the alignment, including manual controls such as dragging or rotating one representation, or tool-assisted alignment such as selecting point(s) in one representation and corresponding point(s) in the other representation and then the tool adjusts the alignment to bring those correspondences together. For single-point selections this could snap both position and normal of the single correspondence pair. Another user input option is for the user to partially refine the alignment (for example drag the representations closer together) and then trigger a tool that automatically refines the alignment per above, this time with better initialization to improve its chances of success.

### Presenting 3D Representations and Content

The 3D representation system may present 3D representations, other representations, and content in various ways. For example, the 3D representation system may directly display 2D content on a 2D display. The 2D content may be untransformed, or resized, cropped, warped, reprojected, or the like. The view of the 2D content may change over time via zooming, panning, rotation, or the like.

As another example, the 3D representation system may use a virtual camera to create a 2D rendering of 3D content. The 2D rendering may be based on the position, orientation, and field of view of the virtual camera. The combination of position and orientation or of position, orientation, and field of view of the virtual camera may be referred to as the perspective of the virtual camera. The virtual camera parameters such as position and orientation may change over time, such as in response to requests to navigate the 3D representation by moving the virtual camera. The 3D representation system may project 2D content into 3D such as by projection onto a flat 3D surface or onto other 3D structures such as point clouds or meshes. A 3D representation may include perspective, orthographic, or other projections. The 3D representation system may use multiple virtual cameras to create stereoscopic content for augmented or virtual reality devices.

The 3D representation system may generate and display a 2D or 3D representation or visualization of spatial data without an explicit 2D or 3D representation (for example, text or other data). The 3D representation system may export content to various file formats such as 2D images or video, 3D file formats, or other file formats including ones that can contain multiple types of content. Other approaches to presenting content are possible.

The 3D representation system may switch between presentation modes or combine presentation modes in various ways. The 3D representation system may also augment content or make it dynamic.

The 3D representation system may place 3D content (including projected 2D content, and 2D content shown in a location based on its associated 3D position) in a common 3D coordinate system and render multiple elements of content from the same virtual camera perspective. The 3D representation system may use 3D occlusion (for example z buffer) to determine which item of content is displayed in each view direction (for example along each pixel ray). The 3D representation system may use transparency or other blending methods to show multiple items of content at the same time, such as a 3D map view with a partially-transparent point cloud or 3D mesh overlaid on it. Certain content may have display priority independent of occlusion, such as showing labels, outlines, or specific elements of content even if such content would be occluded from view based on relative 3D position from the virtual camera.

In various embodiments, to display a portion of a 3D representation that would normally be occluded by another portion of the 3D representation (for example, a 3D mesh of a building interior that would normally be occluded by a Gaussian splat 3D representation of the building exterior and surrounding environment), the 3D representation system may utilize 2D polygons. The 3D representation system may attach the 2D polygons to the 3D representation and render the 2D polygons into a 2D signed distance field (SDF) into an offscreen buffer. The 3D representation system may utilize a particular color or particular colors for the 2D polygons (for example, black or white). A fragment shader of the 3D representation system may query the SDF like other textures and may, based on the color, decide if the pixel should be rendered or not. For example, if the corresponding pixel in the SDF is a particular color (for example, white), the 3D representation system may not render the pixel. The 3D representation system may also apply trims using a building or room's height information. This allows the trim to work on 3D representations that have variable room and floor heights. The 3D representation system may do this by utilizing the G and B channels in the SDF texture to encode floor and ceiling height. The R channel may hold the 2D SDF.

The 3D representation system may display content in dedicated regions of the display, such as having a portion of a screen or display surface that shows a top-view map while the rest of the display shows a virtual camera view. The 3D representation system may display content with transparency or other blending techniques, so that other content can still be seen behind the dedicated display region. In various embodiments, display regions are dynamic. For example, the 3D representation system may display a swipe style control that lets the user drag a separator across the screen with certain items of content visible on one side of the divide and different items of content on the other side of the divide.

The 3D representation system may display or hide content based on an explicit or implicit presentation mode. For example, a user may select a specific view mode such as a dollhouse mode in which certain types of content are visible (for example a 3D mesh) and other types (for example panoramas, map data) are not. As another example, based on user navigation controls, a predetermined or generated presentation sequence or path, or other information available to the 3D representation system, a presentation mode may be selected that presents certain combinations of content and not others. For example, as a user zooms in, the 3D representation system may switch from displaying map data to displaying a 3D mesh or point cloud.

The 3D representation system may display or hide content based on user navigation or other movement of a virtual camera. For example, content may be presented when it is closer to the user's viewpoint and hidden when farther away. One example may include moving from panorama to panorama in a 3D representation as displayed by the presentation component 112. The 2D content of one panorama (projected into 3D) may be hidden (for example, the 2D content may fade out) when its panorama location is moved away from, and the 2D content of another panorama may fade in as the viewpoint reaches its panorama location.

The 3D representation system may display or hide content based on grouping of the content into layers or other organizing structures, or based on its metadata. For example, certain content may be grouped together for certain purposes or named layers such as “virtual staging” or “new landscaping,” and those groups or layers could be presented or hidden together. As another example, content may have times associated with it such as specific dates, times of day, or stages such as “before renovation” and content could be presented or hidden based on a selected time period, an animation over time periods, or the like. Not all content would necessarily have compatible timestamps or any time data at all. The 3D representation system may decide which content to present based on heuristics or other algorithms about which content should be associated with the chosen time or times. A similar approach could be taken for properties or metadata other than time.

The 3D representation system may display or hide content based on indications of user interest. An indication of user interest may be the user hovering a cursor or other input device over or near content, clicking or tapping on or near content, moving or aiming a virtual camera at or near content, entering a search term, or selecting content or type or types of content from a list. An indication of interest could also be used to decide to present related content.

The 3D representation system may display or hide content based on automatic determinations of what would be useful, informative, or pleasing to the user, or based on 3D representation system priorities to emphasize certain content. The 3D representation system may display or hide content based on its relationships to other content that is presented or hidden. For example, a user might click on an object, and that object and other objects of the same type might be presented or highlighted.

In some embodiments, any determination to present or emphasize certain content causes other content to be hidden or deemphasized, and vice versa. For example, if a user clicks on a floor of a building, the 3D representation system may decide to fully display that floor and hide or fade out the other floors.

For any of these methods of deciding to display or hide content, the 3D representation system may partially or gradually display or hide content. For example, the 3D representation system may cause content to fade in or out (such as with transparency) over time or parametrically based on virtual camera position. As another example, the 3D representation system may present content in a partially visible (partially transparent) or otherwise deemphasized form, such as only showing an outline or shape of the content, or fading out its colors. As another example, the 3D representation system may display, hide, or partially or gradually display or hide portions of items of content. For example, the 3D representation system may fully display some points within a single point cloud, other points as partially transparent, and other points as completely hidden. Additionally or alternatively, for a 3D mesh representation that includes indoor and outdoor portions, the 3D representation system may display only the indoor or outdoor portions while hiding the other portions.

The 3D representation system may also allow content to be selected for extra emphasis, deemphasis, or other effects. For example, the 3D representation system may highlight or outline content, or add effects such as animation, color shifting, sparkles or particle effects, or the like to an item of content. As another example, the 3D representation system may display colored or other overlays on content, such as by displaying all objects of a certain type with a blue overlay. As another example, the 3D representation system may position labels, such as room labels, or other indicators, such as room dimensions or areas, relative to the content.

The 3D representation system may display content or other data as overlays or other augmentation of other elements of content. One example is that the 3D representation system may display semantic segmentation or other metadata about content as colored overlays or other effects, such as a 3D mesh having different portions belonging to different semantic classes (wall, floor, furniture, or the like) having different colored overlays to present the semantic segmentation visually. The 3D representation system may display spatial data as effects or overlays on other content rather than presented as its own content, such as traffic or temperature data used to apply colors or other effects to content. The 3D representation system may display metadata or other data as text labels, images, or other content shown with or relative to other content. For example, when viewing a particular panorama, the 3D representation system may present data about when that panorama was captured as text on part of the screen.

### Navigating 3D Representations

Some embodiments of the 3D representation system may enable a user to move between the different modes and presentations in any order. In various embodiments, a user may be allowed to move from one mode and presentation to one or two other modes and presentations (for example, in an order starting from a current view to one step in a direction of a more detailed view or one step of a less detailed view). In some embodiments, the different views may be easily moved quickly through different modes and presentations (for example, zooming at high speed between the different modes and presentations without skipping, the zooming between the different modes and presentations being depicted to the user in a GUI). In other embodiments, the user may zoom between different modes and presentations while skipping one or two different modes and presentations at a time.

The 3D representation system may provide various ways to navigate 2D or 3D representations. For example, the 3D representation system may provide a virtual camera for viewing a 3D representation and receive inputs to navigate the 3D representation by moving the virtual camera in the 3D representation. The 3D representation system may include or enable direct controls for camera translation, orientation, and zooming, such as keyboard or mouse controls that modify the virtual camera parameters. The 3D representation system may smooth or modify movement of the virtual camera caused by the direct controls to make a more pleasing or useful experience, such as interpolating or smoothing motion, applying momentum and decay effects, or the like. As another example, the 3D representation system may allow for navigation of a 3D representation by holding a position of a virtual camera constant and moving the 3D representation relative to the virtual camera.

The 3D representation system may augment navigation by generating detailed navigation paths in response to indications of user interest or navigation goals. For example, if a user selects a spot in a 3D mesh, the 3D representation system may determine a path from the current viewpoint to one near the indicated position and smoothly move the camera along that path (for example, a fly-in path). Or if a user selects a different view mode such as floor plan, the 3D representation system may determine a virtual camera path and sequence of camera parameters that moves the user from their current perspective viewpoint to an orthographic, top-down viewpoint. Another example would be if a user selects the screen or presses a move forward command while in a panorama view mode, and the 3D representation system determines a destination panorama based on the indicated direction and information about panorama connectivity, then chooses and follows a virtual camera path towards that destination panorama location.

The 3D representation system may restrict navigation (relative to free navigation) to make the interface simpler, more intuitive, or to improve the experience. For example, the 3D representation system may restrict movement of the virtual camera so that the virtual camera does not pass through or inside of content that would obstruct its field of view. As another example, the 3D representation system may constrain camera movement to regions where certain content types can be presented with higher quality. One example of constraining the virtual camera movement may involve keeping the virtual camera at the same origin from which a panorama was captured so that the panorama can be displayed without distortion, or keeping the virtual camera close to the input camera positions used to generate a neural radiance field or Gaussian splat representation so that the views generated at the virtual camera positions are higher quality. These constraints on camera movement may be partial constraints. For example, the 3D representation system may allow the virtual camera to move through other positions but have the virtual camera settle or stop only at desirable locations. Or, the 3D representation system may allow the user to override the constraints, or only apply the constraints when the constraints would not unduly modify the indicated navigation goals of the user.

In one implementation, the 3D representation system may identify particular regions in the 3D representation in which a virtual camera for viewing the 3D representation may move as the 3D representation is navigated. The 3D representation system may receive inputs (for example, user inputs) to navigate the 3D representation by moving the virtual camera in the 3D representation. The user inputs may include first inputs to move the virtual camera along a first path of a first type in the 3D representation, such as horizontally along a generally circular path around a vertical axis of the 3D representation. The user inputs may also include second inputs to move the virtual camera along a second path of a second type, different from the first type, in the 3D representation. Moving the virtual camera along the second path may include changing one or more of an altitude of the virtual camera in the 3D representation and a distance of the virtual camera from a central position of the 3D representation. As the virtual camera is moved along the first path or along the second path, a yaw or pitch (as the case may be) of the virtual camera may be changed to aim the virtual camera at a central position of the 3D representation. Additionally or alternatively, a field of view of the virtual camera may be changed. The user inputs may be provided by an input device such as a mouse or a keyboard, and the first inputs may be in or along a horizontal axis of the mouse (for example, moving the mouse left or right) or the keyboard (for example, the left arrow or the right arrow keys). The second inputs may be in or along a vertical axis of the mouse (for example, moving the mouse forward or back) or the keyboard (for example, the up arrow or the down arrow keys).

The 3D representation system may determine one or more paths through the reconstructed space that optimize or improve the experience of viewing the space when a virtual camera is moved along such paths. Optimization criteria may include visual quality of the reconstruction from each camera location, smoothness of the camera path(s), connectivity of the camera path(s) such as forming a seamless loop, or other qualities that affect the experience of viewing the scene along the camera path.

In some embodiments, the 3D representation system may present the 3D representation viewed along such optimized or improved path(s). This can involve viewing the space with predetermined camera movement along the path(s), or it can involve limited user control of the camera movement, such as controlling how the virtual camera moves along or near such paths, or camera orientation or field of view while the movement of the camera origin is still based on the path(s). In various embodiments, the 3D representation system constrains the virtual camera to move only in certain regions in the 3D representation, and allows the virtual camera to move only in or along first paths of a first type and second paths of a second type. For example, the first paths of the first type may be generally circular around a vertical axis located at a central position of the 3D representation and allow the virtual camera to move along a generally circular path around the vertical axis at a generally constant altitude in the 3D representation. The yaw of the virtual camera may change to keep the virtual camera aimed at the central position of the 3D representation. The second paths of the second type may be generally curvilinear and allow the virtual camera to move in towards the vertical axis and down towards the ground or away from the vertical axis and away from the ground. The pitch of the virtual camera may change to keep the virtual camera aimed at the central position of the 3D representation

In another example, 360 images or video may be captured from a drone as it flies in an approximate loop around a property, or from a 360 camera on a tall pole carried by a human or robot. Gaussian splat representation of the space may be trained from the 360 images or video. The 3D representation system may generate a 3D path that forms a loop that is both smooth (no sudden changes in direction) and seamless (end of the loop connects smoothly back to the beginning), and which stays relatively close to the drone flight path. The same or a different system (for example, a mobile phone, a server, or another digital device) may present the space with user controls that allow the user to move their virtual camera along the generated path but not leave it.

In some embodiments, the virtual camera aims at the center of the 3D representation by default, so that with only 1D input (left-right) a user could have the experience of orbiting the property and viewing it from all sides. Additional axes of input could allow the user to look up and down or zoom in and out while still keeping the virtual camera pitch aimed at the center of the property. Fully free virtual camera aim while on the path is also possible.

In various embodiments, constraining movement of the virtual camera offers numerous advantages over arbitrary capture paths and free 3D navigation of the 3D representation. One advantage is that keeping the virtual camera position close to the positions and fields of view where input data was captured may generally increase the visual quality of viewing a Gaussian splat representation. Moving the virtual camera far from the capture locations can make artifacts such as distortions or floaters more visible.

Another advantage is that if virtual camera aim while on the path is restricted (for example, the virtual camera must stay aimed at or near the center of the property), this can maintain the property of staying close to the positions and fields of view where the input data was captured, even if the capture device was not a 360 camera and instead was a narrower field of view camera aimed towards the center of the property or loop during capture.

Yet another advantage is that moving a virtual camera along a smooth path can create a more pleasant or less disorienting viewing experience than allowing sudden changes in direction. A seamless loop means that the user may not suffer any disruptions in navigation such as reaching the end of a path or transitioning harshly from one part of a path to another.

Restricted navigation (along a path, and possibly with limited control of camera aim) can be easier or more intuitive for users than free 3D navigation. Users can use simple controls and have reduced risk of getting lost or disoriented during navigation. If this intended experience is known at the time of capture, then during capture a path can be chosen to make this reconstruction and presentation easier and higher quality than arbitrary capture paths. For example, a drone operator (human or automated) could attempt to fly without sudden direction changes and to fly in a self-connecting loop so that the smoothed, seamless loop can stay as close as possible to the original drone path.

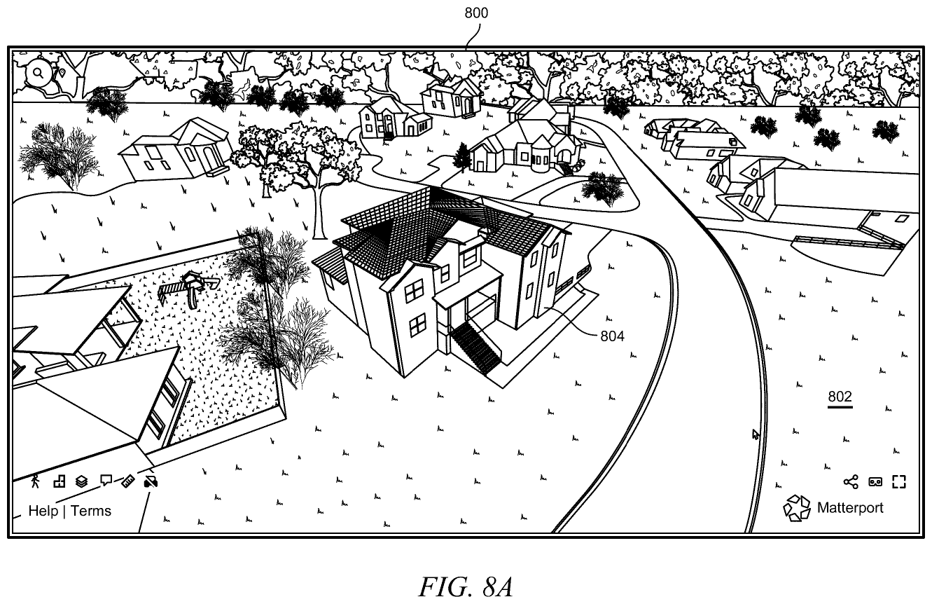

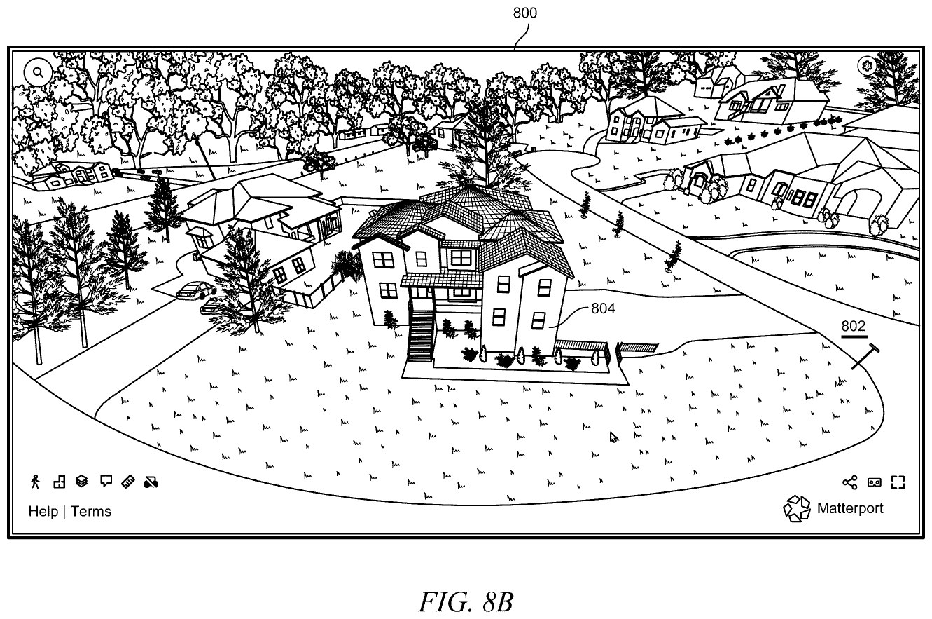

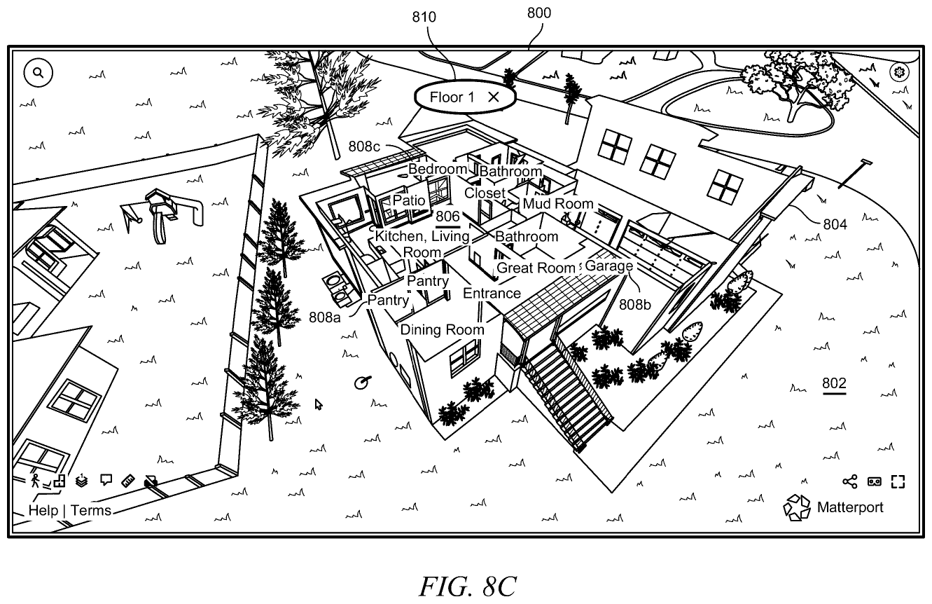

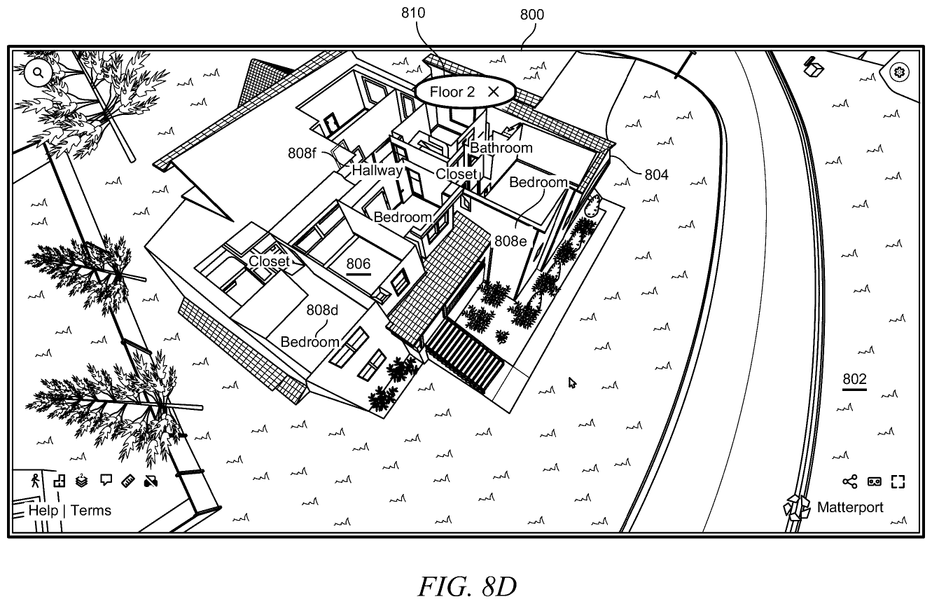

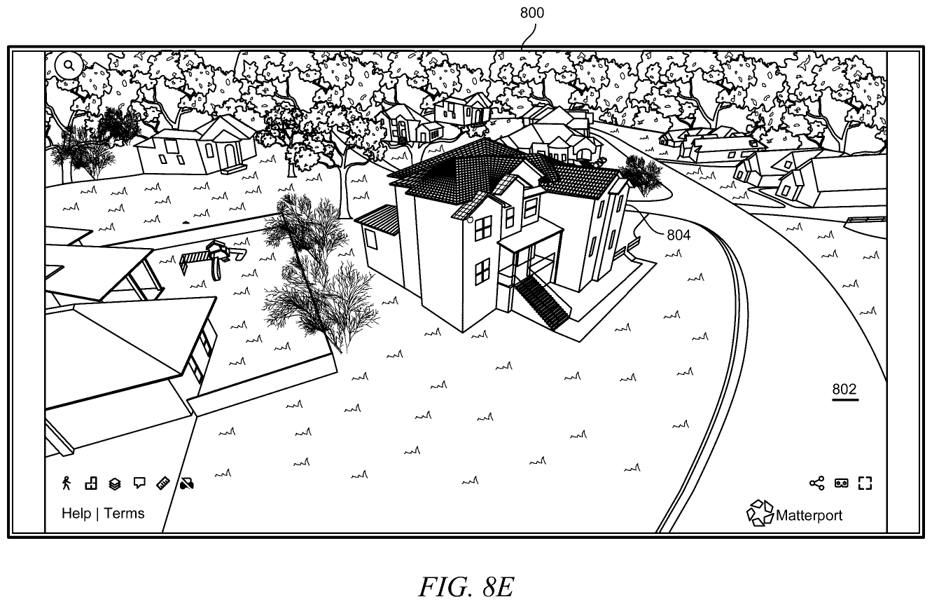

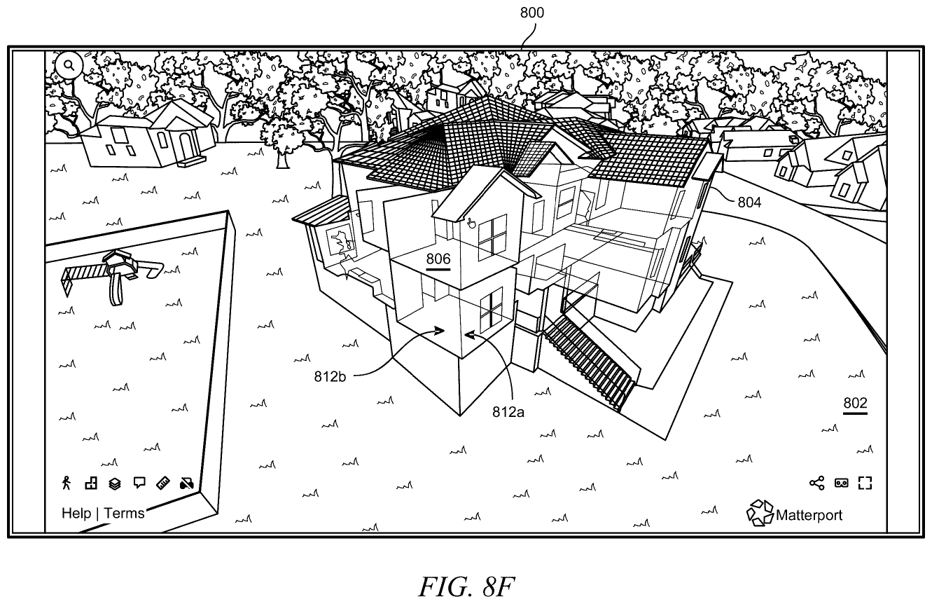

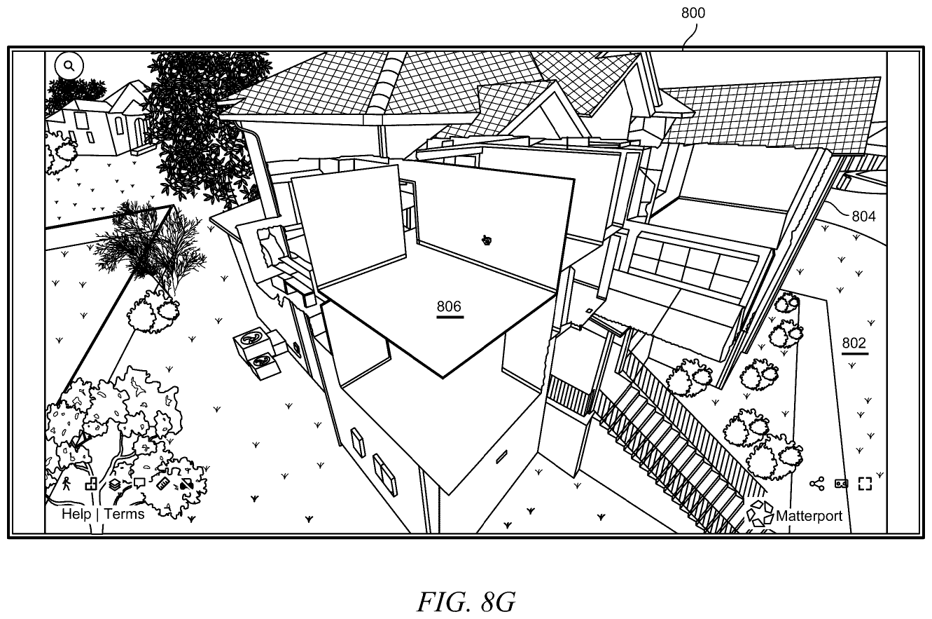

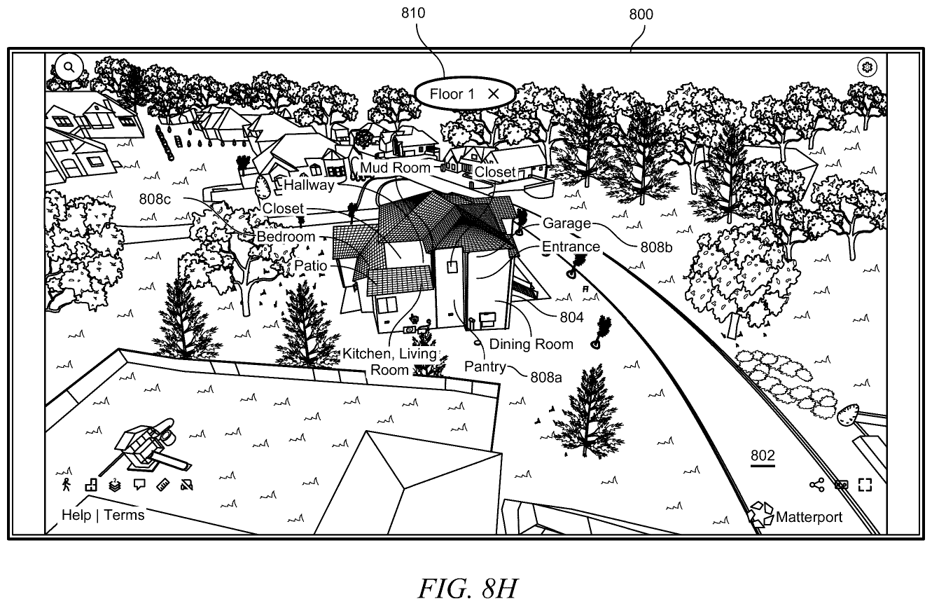

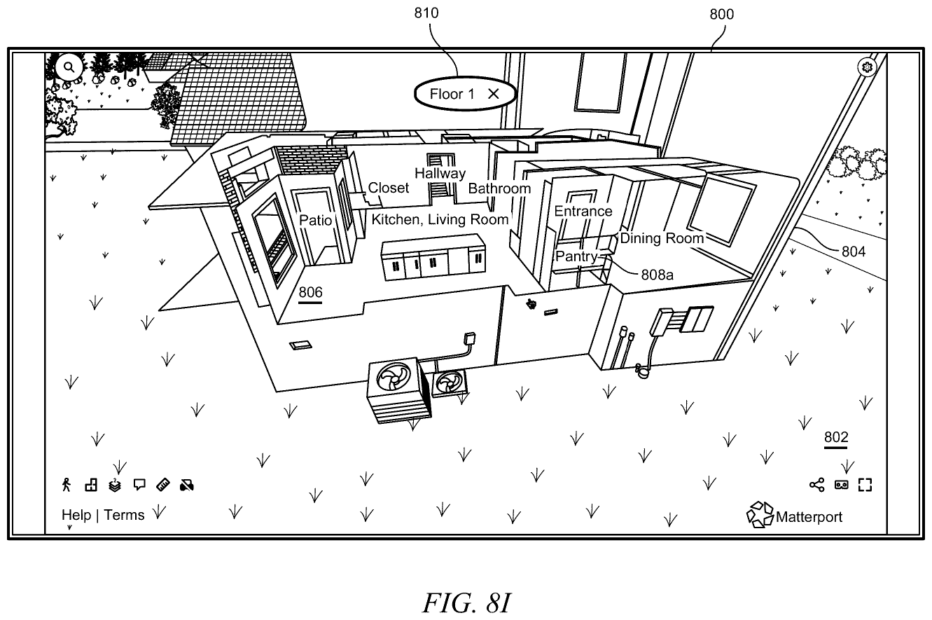

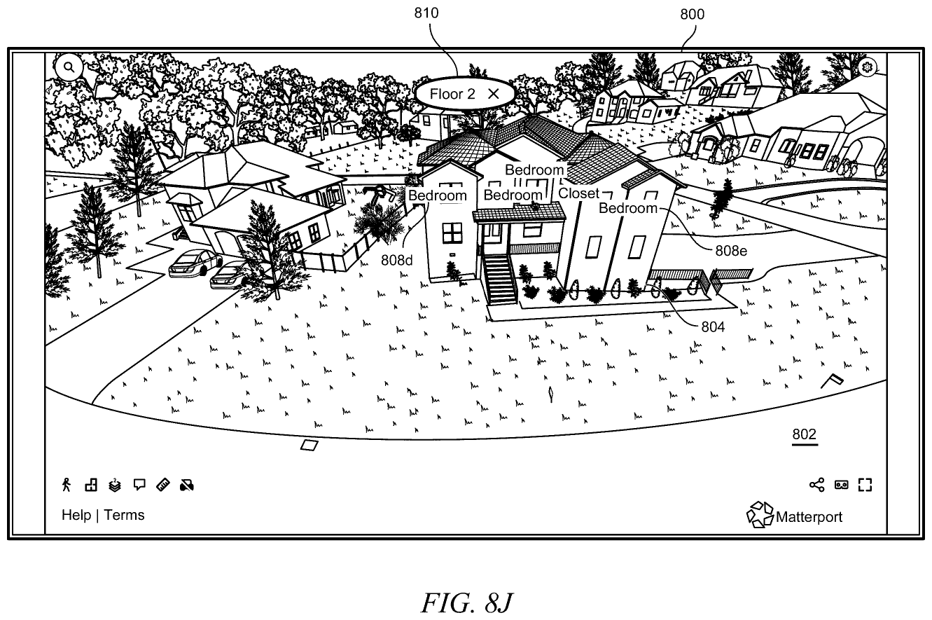

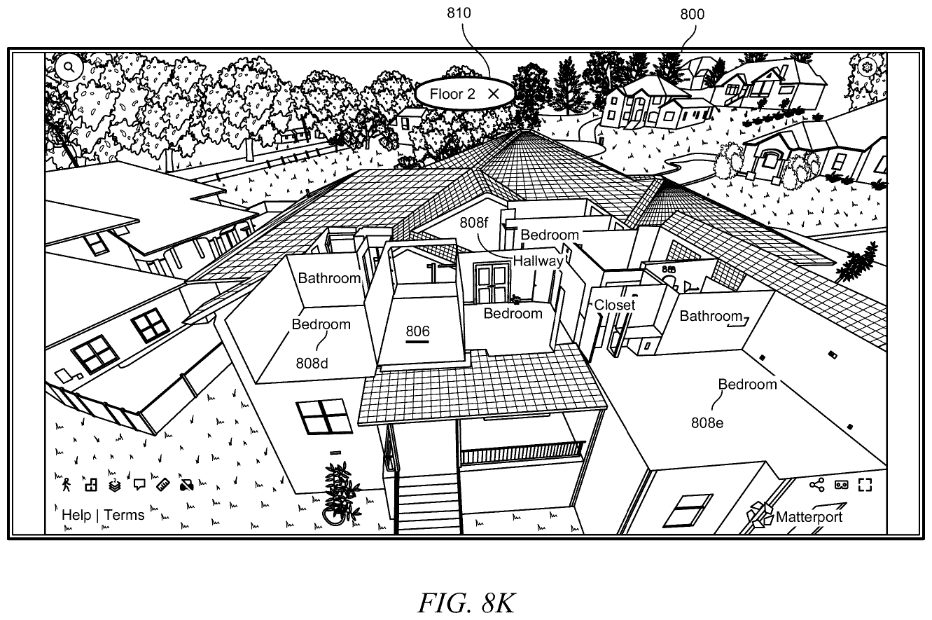

An example experience using a 3D representation system that combines some of these content types and presentation modes could be as follows. A user starts out looking at a building in a viewer, seeing the exterior of the building from an aerial (drone) viewpoint above it. The drone data has been processed into Gaussian splats, which is how the exterior aerial view is rendered, and it lets the user move their viewpoint around smoothly and see the environment from many positions and angles. See, for example, FIGS. 8A and 8B.

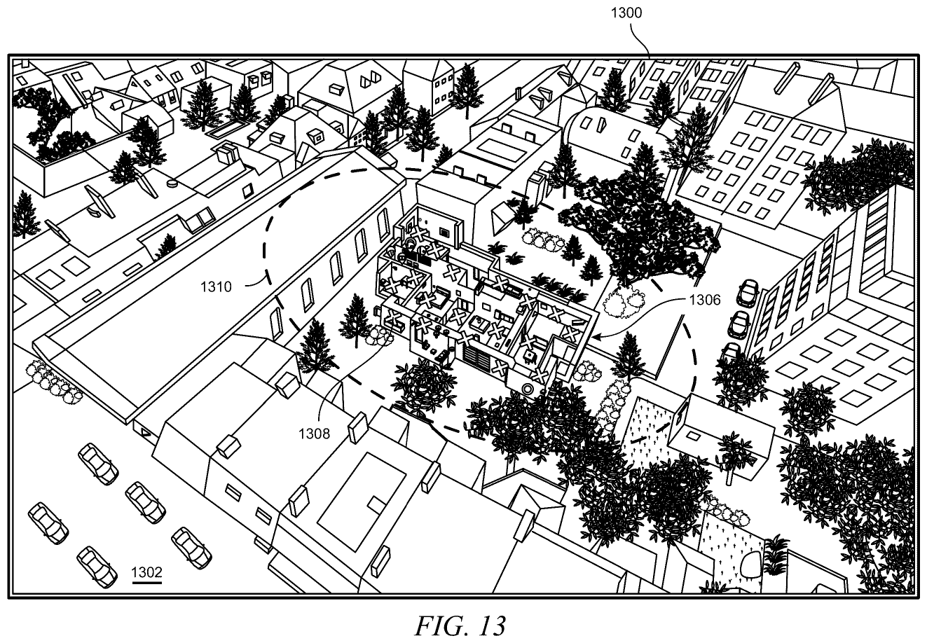

The user then zooms out, and as they do, the view transitions so that the user is seeing 3D mesh tiles of the surrounding neighborhood and geography (for example, see FIG. 13), overlaid with street locations and points of interest as 3D and 2D objects. The splat representation fades out as the 3D mesh fades in, and the user can move their viewpoint around and see the larger context of the space but potentially with lower detail or visual quality. The user could even zoom out smoothly to see the entire earth, using meshes with scaling levels of detail.

The user then zooms back in on the building, transitioning from the 3D mesh tiles back to the Gaussian splat view, and then zooming in further to see a detailed 3D point cloud of the building exterior and grounds that was captured with a laser scanner. As the user zooms in, the regions where the point cloud data is present show the point cloud, and the regions outside that area continue to show the Gaussian splats as a larger context.

As the user zooms in a bit further, the building exterior becomes partially transparent or translucent, and the user can start to see through the walls to the building interior (a 3D mesh). See, for example, FIG. 8F. The user clicks a button for an interior view, and the building exterior (point cloud) is replaced by a 3D mesh of the building interior (dollhouse view), allowing the user to see through the walls and look around at the interior layout and objects within the building. This view also shows outlines of rooms with room labels and measurements to help the user better understand and navigate the space.

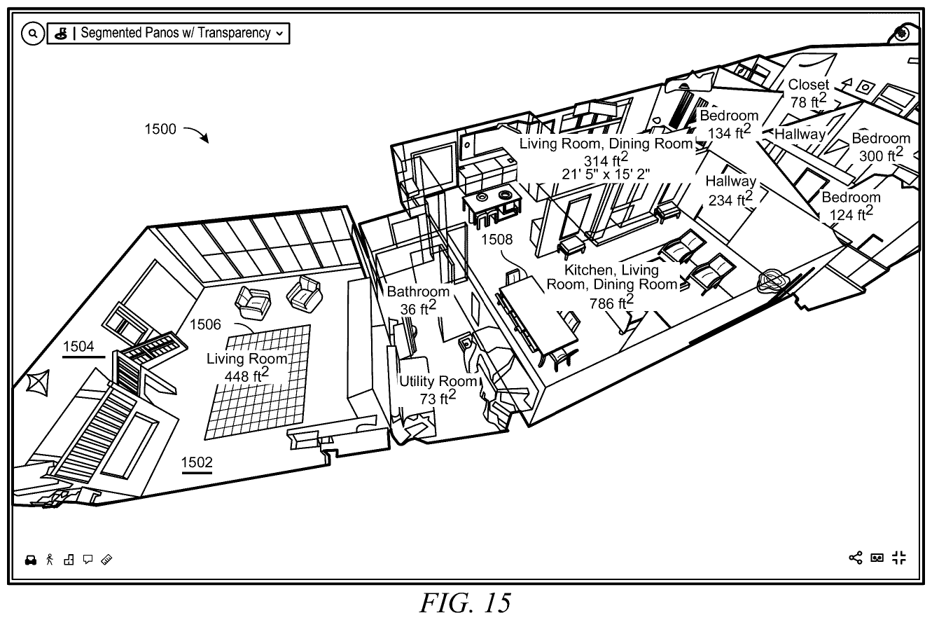

After that, the user clicks on part of the building and the view changes to only show the selected floor of the building, with the rest of the scene fading out to a near-transparent background so the selected region can be seen without distractions (for example, see FIG. 15). The user switches to a floor plan view and the camera parameters smoothly change to show an orthographic top view of the floor, and the visual style changes to look like a schematic floor plan as the room outlines are emphasized and the textured 3D mesh fades.

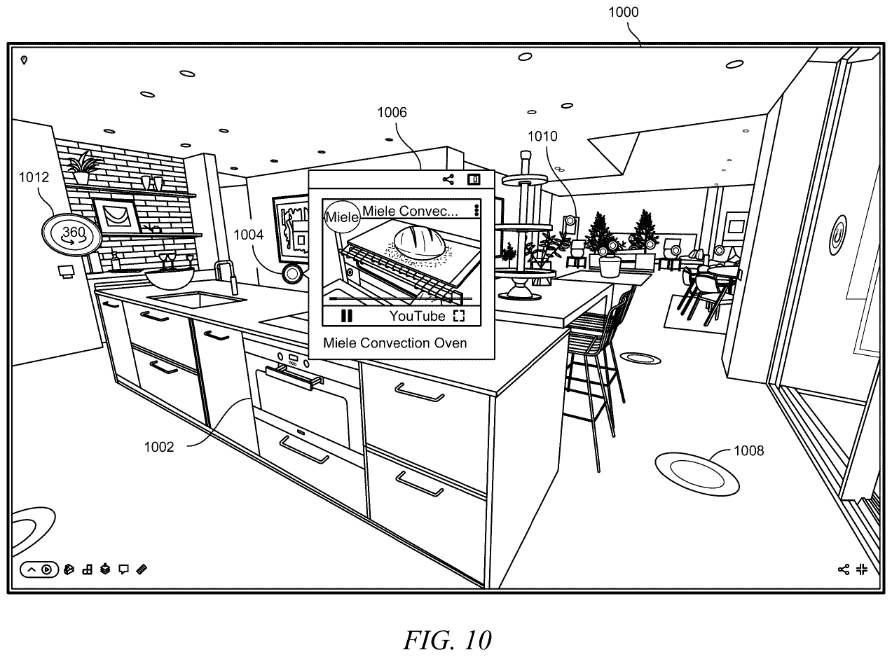

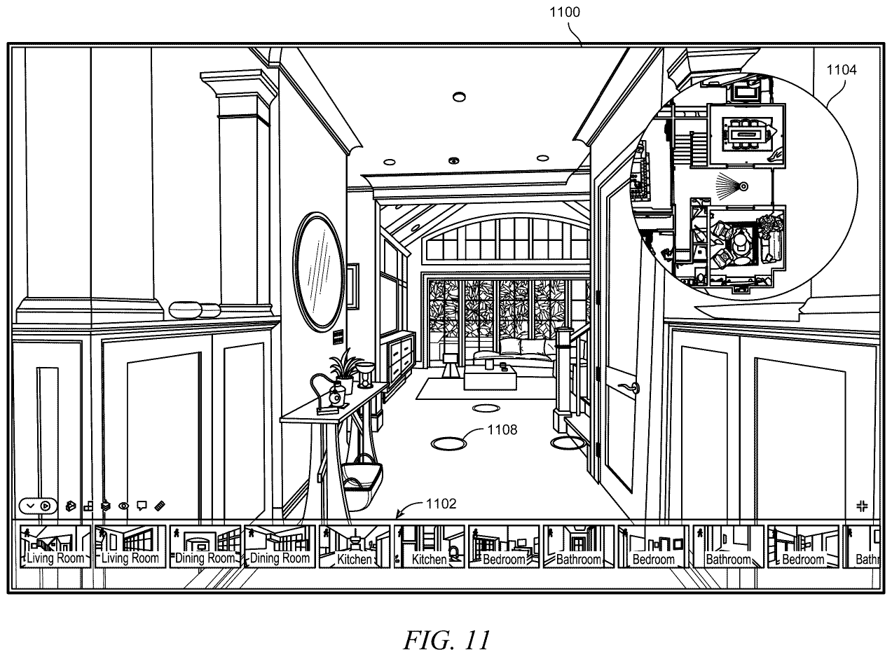

The user then switches back to the dollhouse view of the floor and clicks on a specific spot on the floor. The virtual camera viewpoint flies towards that location and the view changes to a photorealistic 2D panorama that was captured at that location, allowing the user to look around freely from that location. The navigation changes to an interface for walking around inside the space, and when the user indicates they want to move forward, the camera viewpoint moves towards another location ahead of them where the user will be able to view another 2D panorama. As the virtual camera viewpoint moves, the 3D geometry of the space is used to create a smooth, realistic transition between the panoramas as if the camera were moving through the 3D space (for example, see FIGS. 10 and 11).

After exploring inside the space, the user clicks a button to start a guided tour. The camera viewpoint flies back out to the aerial view, transitioning through displaying the different forms of data as it moves, and then starts moving the camera viewpoint through a series of motions designed to show various aspects of the property, along with changing the display modes to complement the camera motion. It will be appreciated that, in some embodiments, the user may engage any or all of these views in any order.

### Automatically Generating Descriptions

Traditionally, the description of a property is added manually to the MLS listing page by agents, homeowners, or property managers. This is one of the landing blocks in a listing page that attracts buyers and draws attention to the property, thereby leading to a showing or an offer. Normally, the agents are required to know their property well in advance to highlight the unique features and the process is entirely manual.

Most of the time, agents copy the description from the last known listing of the property. The previous description, however, will not be updated with any recent upgrades. Further, the previous description may have been poorly written and not discuss important aspects of the property. As a result, the property is poorly understood by buyers (and perhaps sellers) who rely on the re-used description.

In various embodiments, property information and metadata including, for example, square footage, dimensions, floors, neighborhoods, amenities, features, proximity to shopping and schools, surrounding demographic information, and the like may be provided (for example, via an agent) to a large language model (LLM) that is prompted to use the information to generate a description. In some embodiments, the prompt for the description includes instructions to market and promote the property using the details regarding the property.

For example, the LLM may be prompted to produce space highlights to show the functional value or something unique about that space. An example result may be: “Spacious kitchen, a great blend of comfort and functionality, ideal choice for families or individuals looking for a spacious and well-designed living space.”

As another example, the LLM may be prompted to describe objects in the space. An example result may be: “This home is perfect for outdoor living, with its oversized backyard that includes an above ground pool for the hot summer days. Aim to use the most important objects like windows, lightening, cabinets and storage.”

As another example, the LLM may be prompted to describe the floor plan. An example result may be: “The property has 3 bedrooms and 2 full bathrooms.” As another example, the LLM may be prompted to describe the floor area. An example result may be: “The building described in the data is a single-story structure with a total floor area of approximately 31 square meters.” As another example, the LLM may be prompted to describe the location: An example result may be: “Nestled in the vibrant neighborhood of Berryessa in the city of Milpitas.”

It will be appreciated that metadata of the property or surrounding area may be used to generate further description. Examples of metadata of the surrounding area may include neighborhood location, neighborhood information (for example, density), crime rates, value of the space in comparison, school district, energy efficiency, accessibility, historical value, or the like.

In various embodiments, a standard prompt for the LLM may be applied. A user (for example, a seller or agent) may replace or enhance the prompt for their particular needs (for example, tone, information density of description, preferences to highlight certain features, or minimize other features). In some embodiments, the user may use a prompt generator. A prompt generator may be or include an LLM that may receive information from the user regarding their needs and preferences for the description. Based on this input, the prompt generator may generate a prompt for the LLM to generate a description using the property or metadata information as well as the prompt. In some embodiments, a second agent or LLM may review and compare the description against the user's input or prompt generator's prompt for consistency. If the second agent or LLM determines improvements can be made, the second agent or LLM may make changes to the prompt to generate an improved description and provide the modified prompt to the original LLM to generate a new description.

An automatic or LLM-generated description of the property may be focused on the property as a whole or on a particular part of the property. For example, the description may describe a scene from a particular point of view, a room, set of rooms, a floor, the building, the surrounding exterior of the building, or a description of the property as a whole. In some embodiments, a user (for example, buyer) may have the option to look at different descriptions for different parts of the property. For example, an agent may provide or trigger prompts to generate descriptions for each floor, for the building as a whole, and for the gardens and surrounding land outside the building. The descriptions may be available online such that the buyer may review all the descriptions or select (for example, via interacting with a software element such as a tab, button, or pull down menu) the desired description for review.

As described in U.S. patent application Ser. No. 19/081,905, titled “Systems and Methods for Navigational and Informational Assistance for Digital Twins,” which is incorporated by reference herein in its entirety, in one example, a user (for example, a real estate agent or seller) may provide a request of a description of a particular room of a house of a 3D model through a chat agent. Information may be retrieved regarding the residence from any number of external or local sources. The request may be provided (for example, either processed to generate a separate query or directly) to an LLM that is configured to utilize the information about the house to form a response including a description of a particular room, building, or the like.

The 3D representation system may use such automatic or LLM-generated descriptions as content displayed as part of the 3D representations.

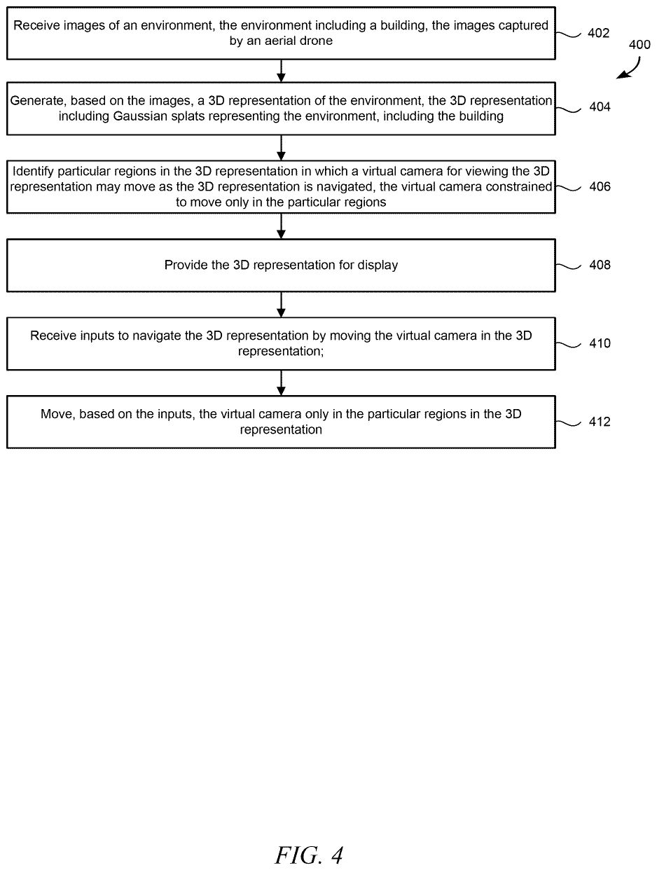

FIG. 4 is a flow diagram depicting a method 400 for moving a virtual camera in a 3D representation in some embodiments. The 3D representation system (for example, various components of the 3D representation system) may perform the method 400. The method 400 may begin at step 402, where the 3D representation system may receive images of an environment. The environment may include a building, and the images may be captured by an aerial drone. At step 404 the 3D representation system may generate, based on the images, a 3D representation of the environment. For example, the 3D representation may include Gaussian splats representing the environment, including the building.

At step 406 the 3D representation system may identify particular regions in the 3D representation in which a virtual camera for viewing the 3D representation may move as the 3D representation is navigated. The virtual camera may be constrained to move only in the particular regions. The particular regions may be less than an entirety of the 3D representation. At step 408 the 3D representation system may provide the 3D representation for display. At step 410 the 3D representation system may receive inputs to navigate the 3D representation by moving the virtual camera in the 3D representation. At step 412 the 3D representation system may move, based on the inputs, the virtual camera only in the particular regions in the 3D representation.

In some embodiments, the method 400 may include a step where the 3D representation system may identify particular orientations that the virtual camera may have as the virtual camera moves in the particular regions in the 3D representation. The virtual camera may be constrained to have only the particular orientations, the particular orientations less than an entirety of all orientations. Positions, orientations, or positions and orientations in the 3D representation may have quality attributes, and the 3D representation system may identify the particular regions in the 3D representation in which the virtual camera may move and the particular orientations that the virtual camera may have by identifying, based on the quality attributes, the particular regions having particular positions, orientations, or positions and orientations having quality attributes above a threshold.

In various embodiments, the method 400 may include a step where the 3D representation system may determine positions of the aerial drone in the environment at which the aerial drone captured the images. The 3D representation system may identify the particular regions in the 3D representation in which the virtual camera may move as the 3D representation is navigated by identifying, based on the positions of the aerial drone in the environment at which the aerial drone captured the images, the particular regions in the 3D representation in which the virtual camera may move as the 3D representation is navigated.

In some embodiments, the method 400 may include a step where the 3D representation system may determine one or more central positions of the 3D representation. The 3D representation system may identify the particular regions in the 3D representation in which the virtual camera may move as the 3D representation is navigated by identifying, based on the one or more central positions of the 3D representation, the particular regions in the 3D representation in which the virtual camera may move as the 3D representation is navigated. The 3D representation may include a building 3D representation of the building, and the building 3D representation may be located at a central position of the 3D representation.

In various embodiments, the 3D representation system may receive the inputs to navigate the 3D representation by moving the virtual camera in the 3D representation by receiving first inputs to move the virtual camera along a first path of a first type in the 3D representation and receiving second inputs to move the virtual camera along a second path of a second type, the second type different from the first type, in the 3D representation. The first inputs may be in or along a horizontal axis of an input device and the second inputs may be in or along a vertical axis of the input device. The method 400 may include a step where the 3D representation system may move, based on the first inputs, the virtual camera along a generally circular path around a vertical axis of the 3D representation at a generally constant altitude in the 3D representation, the vertical axis located at a central position of the 3D representation, and may aim a yaw of the virtual camera at the central position of the 3D representation. The method 400 may also include a step where the 3D representation system may change, based on the second inputs, one or more of an altitude of the virtual camera in the 3D representation, a distance of the virtual camera from a central position of the 3D representation, a pitch of the virtual camera, and a field of view of the virtual camera.

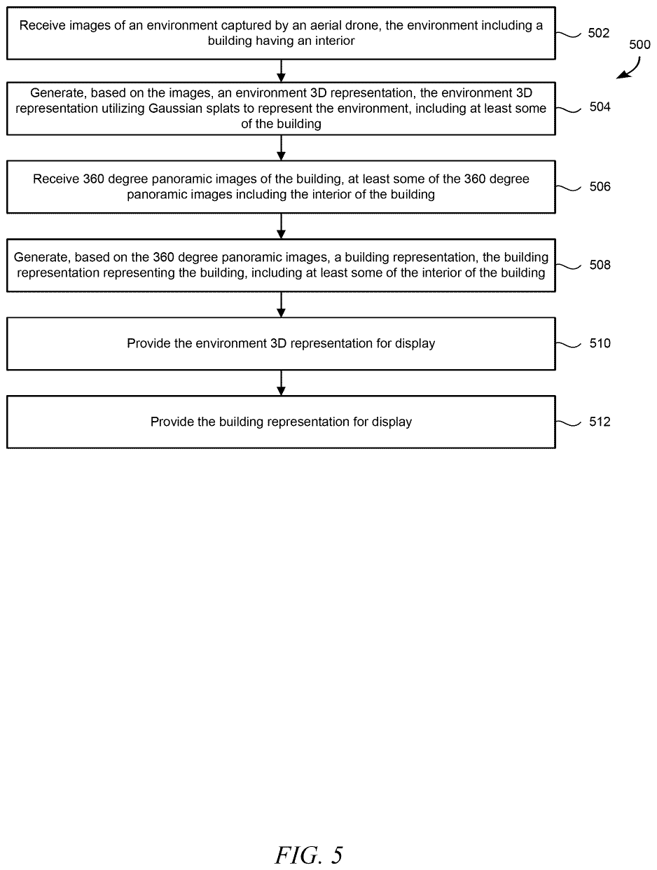

FIG. 5 is a flow diagram depicting a method 500 for generating a 3D representation of an environment and a 3D representation of a building according to some embodiments. The 3D representation system (for example, various components of the 3D representation system) may perform the method 500. The method 500 may begin at step 502, where the 3D representation system may receive images of an environment captured by an aerial drone. The environment may include a building having an interior. At step 504 the 3D representation system may generate, based on the images, an environment 3D representation. The environment 3D representation may utilize Gaussian splats to represent the environment, including at least some of the building. At step 506 the 3D representation system may receive 360 degree panoramic images of at least some of the building. At least some of the 360 degree panoramic images may include at least some of the interior of the building. At step 508 the 3D representation system may generate, based on the 360 degree panoramic images, a building representation. The building representation may represent at least some of the building, including at least some of the interior of the building. At step 510 the 3D representation system may provide the environment 3D representation for display. At step 512 the 3D representation system may provide the building representation for display.

In some embodiments, the method 500 may include steps where the 3D representation system may receive first inputs to navigate the environment 3D representation by moving a first virtual camera for viewing the environment 3D representation in the environment 3D representation, may move, based on the first inputs, the first virtual camera in the environment 3D representation, may receive second inputs to navigate the building representation by moving a second virtual camera for viewing the building representation in the building representation, and may move, based on the second inputs, the second virtual camera in the building representation.

In various embodiments, the method 500 may include steps where the 3D representation system, while displaying one of the environment 3D representation and the building representation, may receive a third input to select the other of the environment 3D representation and the building representation for display and may display the other of the environment 3D representation and the building representation. The 3D representation system may receive the third input to select the other of the environment 3D representation and the building representation for display by receiving a selection of one of an environment user interface element for requesting that the environment 3D representation be displayed and a building user interface element for requesting that the building representation be displayed. The 3D representation system may receive the third input to select the other of the environment 3D representation and the building representation for display by receiving an input to move one of the first virtual camera towards the building representation and the second virtual camera towards the environment 3D representation. The method 500 may include a step where the 3D representation system may transition from displaying the environment 3D representation from a first perspective of the first virtual camera to displaying the building representation from a second perspective of the second virtual camera or from displaying the building representation from the second perspective of the second virtual camera to displaying the environment 3D representation from the first perspective of the first virtual camera.

In some embodiments, the 360 degree panoramic images may be associated with capture locations in the environment, including in the interior of the building, the building representation may include waypoints corresponding to the capture locations at which the 360 degree panoramic images may be displayed, and at least one first waypoint and at least one second waypoint may be linked such that the at least one first waypoint and the at least one second waypoint may be navigated between.

In various embodiments, the method 500 includes a step where the 3D representation system may align the environment 3D representation with the building representation.

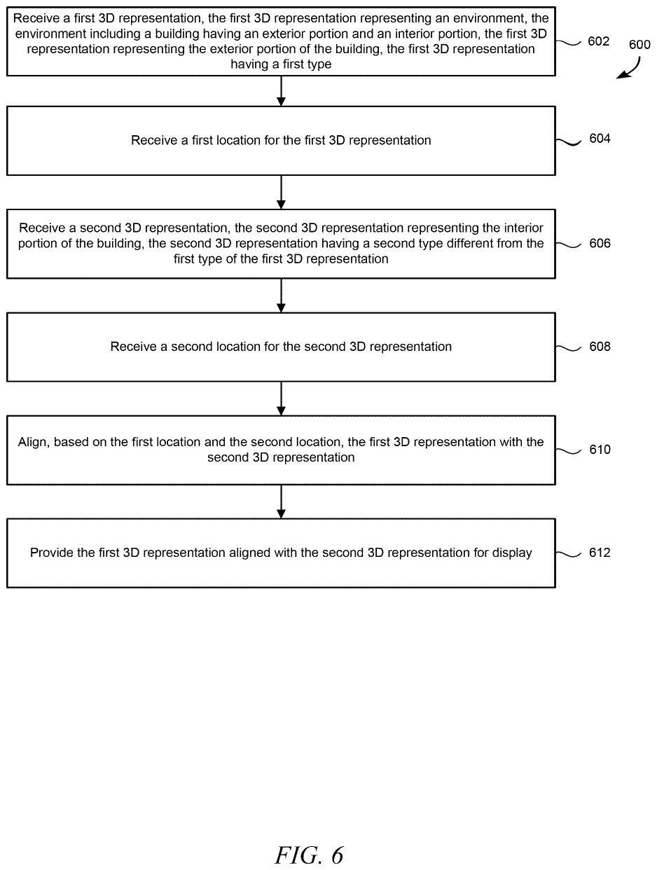

FIG. 6 is a flow diagram depicting a method 600 for aligning two 3D representations having different types in some embodiments. The 3D representation system (for example, various components of the 3D representation system) may perform the method 600. The method 600 may begin at step 602 where the 3D representation system may receive a first 3D representation. The first 3D representation may represent an environment. The environment may include a building having an exterior portion and an interior portion. The first 3D representation may include the exterior portion of the building. The first 3D representation may have a first type.

At step 604 the 3D representation system may receive a first location for the first 3D representation. At step 606 the 3D representation system may receive a second 3D representation. The second 3D representation may represent the interior portion of the building. The second 3D representation may have a second type different from the first type of the first 3D representation. At step 608 the 3D representation system may receive a second location for the second 3D representation. At step 610 the 3D representation system may align, based on the first location and the second location, the first 3D representation with the second 3D representation. At step 612 the 3D representation system may provide the first 3D representation aligned with the second 3D representation for display.

In some embodiments, the method 600 may include steps where the 3D representation system may receive multiple third locations associated with the first 3D representation, may determine, based on the multiple third locations, the first location for the first 3D representation, may receive multiple fourth locations associated with the second 3D representation, and may determine, based on the multiple fourth locations, the second location for the first 3D representation. The multiple third locations may include multiple GPS locations, and the 3D representation system may determine, based on the multiple third locations, the first location for the first 3D representation by applying a fitting algorithm to the multiple GPS locations to determine the first location.

In various embodiments, the method 600 may include steps where the 3D representation system may receive a first altitude for the first 3D representation and may receive a second altitude for the second 3D representation. The 3D representation system may align the first 3D representation with the second 3D representation further based on the first altitude and the second altitude.

The environment may further include the ground, the first 3D representation may further represent a first portion of the ground, and the second 3D representation may further represent a second portion of the ground. The method 600 may also include steps where the 3D representation system may determine, based on the first portion of the ground, the first altitude and may determine, based on the second portion of the ground, the second altitude.

The environment may further include the ground, the first 3D representation may further represent a portion of the ground, and the building may include one or more stories. The method 600 may also include steps where the 3D representation system may determine, based on the portion of the ground, the first altitude, may determine a lowest story of the one or more stories, and may determine, based on the first altitude and the lowest story, the second altitude.

The method 600 may also include steps where the 3D representation system may determine the first altitude, may apply a fitting algorithm to fit at least a first portion of the first 3D representation to at least a second portion of the second 3D representation, and may determine, based on the first altitude and applying the fitting algorithm, the second altitude.

In some embodiments, the method 600 may include steps where the 3D representation system may identify first geometric features of the first 3D representation and second geometric features of the second 3D representation that correspond to the first geometric features and may realign, based on the first geometric features and the second geometric features, the first 3D representation with the second 3D representation.

In some embodiments, the method 600 may include steps where the 3D representation system may receive building data for the second 3D representation, the building data including one or more boundaries of the building, may determine, based on the second 3D representation, the building data, or both the second 3D representation and the building data, an exterior shape of the building, and may realign, based on the exterior portion of the building represented by the first 3D representation and the exterior shape of the building, the first 3D representation with the second 3D representation. The method 600 may also include steps where the 3D representation system may display the first 3D representation and the second 3D representation, may receive one or more inputs for realigning the first 3D representation with the second 3D representation, and may realign, based on the one or more inputs, the first 3D representation with the second 3D representation. The 3D representation system may receive the one or more inputs by receiving a first input selecting a first portion of the first 3D representation and receiving a second input selecting a second portion of the second 3D representation and may realign, based on the one or more inputs, the first 3D representation with the second 3D representation by realigning, based on the first portion of the first 3D representation and the second portion of the second 3D representation, the first 3D representation with the second 3D representation.

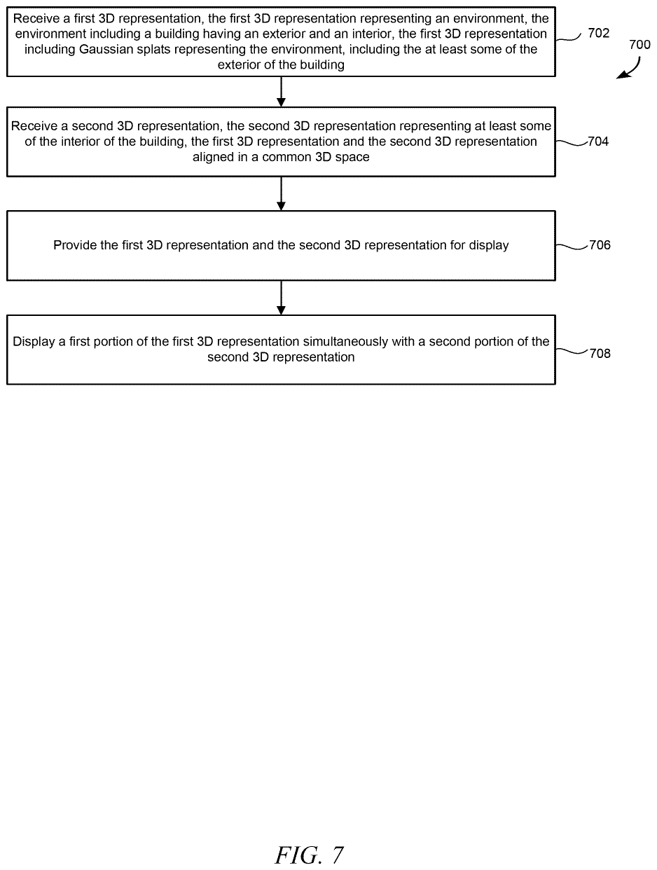

FIG. 7 is a flow diagram depicting a method 700 for displaying a 3D representation of an environment and a 3D representation of a building interior simultaneously according to some embodiments. The 3D representation system (for example, various components of the 3D representation system) may perform the method 700. The method 700 may begin at step 702, where the 3D representation system may receive a first 3D representation. The first 3D representation may represent an environment. The environment may include a building having an exterior and an interior. The first 3D representation may include Gaussian splats representing the environment, including at least some of the exterior of the building.

At step 704 the 3D representation system may receive a second 3D representation. The second 3D representation may represent at least some of the interior of the building. The first 3D representation and the second 3D representation may be aligned in a common 3D space. At step 706 the 3D representation system may provide the first 3D representation and the second 3D representation for display. At step 708 the 3D representation system may display a first portion of the first 3D representation simultaneously with a second portion of the second 3D representation.

In various embodiments, the second 3D representation representing at least some of the interior of the building may include one or more of Gaussian splats, a 3D mesh, a wireframe, or a floor plan positioned and scaled in 3D.

In some embodiments, the second 3D representation may further represent at least some of the exterior of the building and the second portion of the second 3D representation may represent at least some of the interior of the building.

In various embodiments, the building may include one or more stories, and the second portion of the second 3D representation may represent at least one story of the one or more stories.

In some embodiments, the building may include one or more rooms, and the second portion of the second 3D representation may represent at least one room of the one or more rooms.

In various embodiments, the method 700 may include steps where the 3D representation system may identify the second portion of the second 3D representation for display and may identify, based on the second portion, the first portion of the first 3D representation for display. The building may include a roof, exterior walls, one or more stories and one or more rooms on the one or more stories. The 3D representation system may identify the second portion of the second 3D representation for display by identifying at least one story of the one or more stories or at least one room of the one or more rooms, and may identify, based on the second portion, the first portion of the first 3D representation for display by identifying, based on the at least one story or the at least one room, a first portion of the first 3D representation that excludes at least some of the roof or at least some of the exterior walls.

The 3D representation system may display the first portion of the first 3D representation simultaneously with the second portion of the second 3D representation by displaying the second portion of the second 3D representation that would otherwise be occluded by displaying the first portion of the first 3D representation. The 3D representation system may display the first portion of the first 3D representation simultaneously with the second portion of the second 3D representation by displaying at least some of the first portion of the first 3D representation as partially transparent and at least some of the second portion of the second 3D representation as partially visible.

In some embodiments, the building may include one or more rooms. The method 700 may include a step where the 3D representation system may receive building data. The building data may include one or more of a floor plan of the building, one or more dimensions or one or more boundaries of the one or more rooms of the building, or one or more classifications of the one or more rooms of the building. The method 700 may include other steps where the 3D representation system may provide the building data for display and may display at least some of the building data simultaneously with the first portion of the first 3D representation and the second portion of the second 3D representation. The one or more classifications of the one or more rooms of the building may include one or more room labels of the one or more rooms.

FIG. 8A to 8K depict 3D representations of an environment and of a building viewed from different perspectives of a virtual camera. Although discussed in a numerical order, it will be appreciated that in some embodiments a user can navigate from one depiction to another in any order (for example, from FIG. 8H to FIG. 8A). FIG. 8A depicts an interface 800 displaying a 3D representation 802 of an environment viewed from a virtual camera. The environment includes a building that is represented by a building representation 804. The 3D representation system may display the 3D representation 802 (for example, using one or more display devices) using the interface 800. The interface 800 includes multiple user interface elements for interacting with the 3D representation 802, such as a user interface element for exploring the 3D representation 802, a user interface element for viewing a floor plan of the 3D representation 802, a user interface element for selecting a story of the building representation 804, a user interface element for taking measurements of content in the 3D representation 802, and a user interface element for defurnishing or removing furniture and other content in the 3D representation 802. As discussed herein, a user may select the user interface elements to interact with different aspects of the 3D representation 802, and the user may also utilize a user input device such as a mouse, keyboard, or touchscreen to provide user inputs to navigate in the 3D representation 802.

The 3D representation may have a type. Types of 3D representations include but are not limited to 3D meshes or other 3D surface representations, point clouds or other 3D clouds, radiance fields or other neural representations, and voxel or other volumetric or solid representations. In some embodiments, the 3D representation 802 includes or utilizes Gaussian splats to represent the environment, including the exterior of the building representation 804.

As described herein, the virtual camera may be moved in the 3D representation 802 to change the perspective of the virtual camera. Alternatively, the virtual camera may not be moved, and the 3D representation 802 may be moved relative to the virtual camera to change the perspective of the virtual camera. Either approach or a combination of both approaches are possible. The virtual camera is described herein as being moved or moving in the 3D representation 802, but it will be understood that the 3D representation 802 may move or be moved while the virtual camera is held stationary, or that both the virtual camera and the 3D representation 802 may move to change the perspective of the virtual camera.

FIG. 8B depicts the 3D representation 802 from another perspective of the virtual camera. FIG. 8C depicts a portion of the 3D representation 802 displayed simultaneously with a portion of another 3D representation 806 representing a portion of the interior of the building representation 804. The 3D representation 806 may have a type different from the type of the 3D representation 802. In some embodiments, the 3D representation 806 includes or utilizes a 3D mesh to represent the interior of the building.

The 3D representation system may display the portion of the 3D representation 806 after the user has selected the user interface element for selecting a floor or story of the building representation 804 (as indicated by the user interface element 810) and the user has provided inputs to move the virtual camera towards the building representation 804. The 3D representation system may hide or otherwise not display a portion of the 3D representation 802 so that the portion of the 3D representation 806 is visible to the virtual camera. The 3D representation system may automatically hide the portion of the 3D representation 802 as the user moves the virtual camera towards the building representation 804 so as to display the portion of the 3D representation 806. The 3D representation system may also automatically display the previously hidden portion of the 3D representation 802 as the user moves the virtual camera away from the building representation 804, thereby hiding the previously displayed portion of the 3D representation 806.

FIG. 8C also depicts that building data, in the form of room labels 808 (shown individually as room label 808a for a pantry, room label 808b for a garage, and room label 808c for a bedroom), may be displayed along with the portion of the 3D representation 806. FIG. 8D depicts a different portion of the 3D representation 802 displayed simultaneously with a different portion of the 3D representation 806 representing a different portion of the interior of the building representation 804. As indicated by the user interface element 810, the portion of the 3D representation 806 depicted in FIG. 8D corresponds to the second story or floor of the building representation 804. Room labels 808 (shown individually as room label 808d for a bedroom, room label 808e for another bedroom, and room label 808f for a hallway) for rooms on the second story or floor are also depicted in FIG. 8D.

FIG. 8E depicts the 3D representation 802 from another perspective of the virtual camera. FIG. 8F depicts a portion 812 a of the 3D representation 802 displayed as partially transparent so that a portion 812 b of the 3D representation 802 is partially visible. FIG. 8G depicts a portion of the 3D representation 802 displayed simultaneously with a portion of the 3D representation 806. FIG. 8H depicts the 3D representation 802 along with building data in the form of room labels 808 (shown individually as room label 808a for a pantry, room label 808b for a garage, and room label 808c for a bedroom) for rooms on the first floor or story of the building representation 804. FIG. 8I depicts another portion of the 3D representation 802 displayed simultaneously with another portion of the 3D representation 806 along with a room label 808a for the pantry on a first floor or story of the building representation 804. FIG. 8J depicts another portion of the 3D representation 802 displayed along with building data in the form of room labels 808 (shown individually as room label 808d for a bedroom, and room label 808e for another bedroom) on a second floor or story of the building representation 804. FIG. 8K depicts another portion of the 3D representation 802 and another portion of the 3D representation 806 from another perspective of the virtual camera. FIG. 8K also depicts building data in the form of room labels 808 (shown individually as room label 808d for a bedroom, room label 808e for another bedroom, and room label 808f for a hallway) on a second floor or story of the building representation 804.

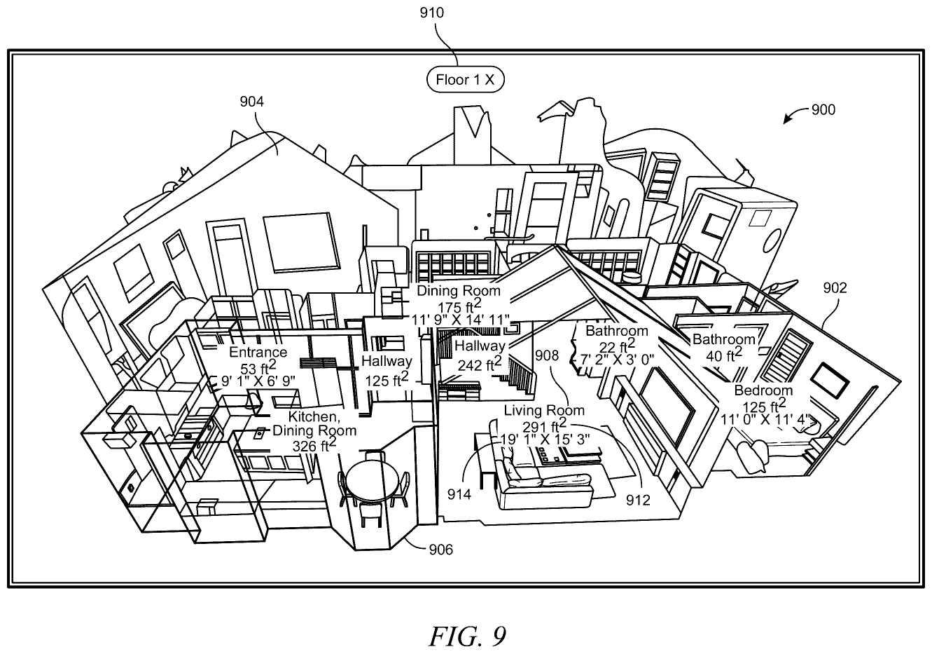

FIG. 9 depicts another 3D representation 900 of a building along with building data. FIG. 9 depicts a dollhouse view of a 3D mesh, where one floor (for example, floor 902) of the building is highlighted (as indicated by user interface element 910) and the other floors are de-emphasized by being partially transparent (for example, floor 904). FIG. 9 also shows additional layers of content (3D room boundaries 906, room labels 908, room areas 912 and room dimensions 914) placed in the same 3D coordinate system, and some of that content is partially hidden based on the 3D geometry (room boundaries lines in the back are partially hidden by the walls of the room).

FIG. 10 depicts a 3D representation 1000 of a room of a building and content for the room. FIG. 10 depicts an inside view of a space with multiple types of content in the same 3D coordinate system, including 2D content such as the MatterTag dot 1004, the MatterTag dot 1010 and the details pane 1006 that are shown based on their associated 3D locations. FIG. 10 also shows content based on an explicit mode (user interface elements for changing mode to dollhouse or floorplan are in the bottom left). The depiction in FIG. 10 further shows content being displayed in response to an indication of user interest, as the details pane 1006 showing “Miele Convection Oven” is expanded due to the user hovering over (for example, with the mouse cursor) or selecting the MatterTag dot 1004 for the oven 1002. The 360 icon 1012 and the ring 1008 (pucks) on the floor are projected 2D content, and the ring 1008 and other rings also show the constrained virtual camera movement options.

FIG. 11 depicts another 3D representation 1100 of a room in a building with content for the room. FIG. 11 depicts content elements in dedicated regions of the display: the minimap 1104 in the top right showing an alternate view of the 3D content plus spatial data about the current camera position and view direction, and the highlight reel 1102 along the bottom which contains additional content and navigation links. The ring 1108 and the other rings show the constrained virtual camera movement options.

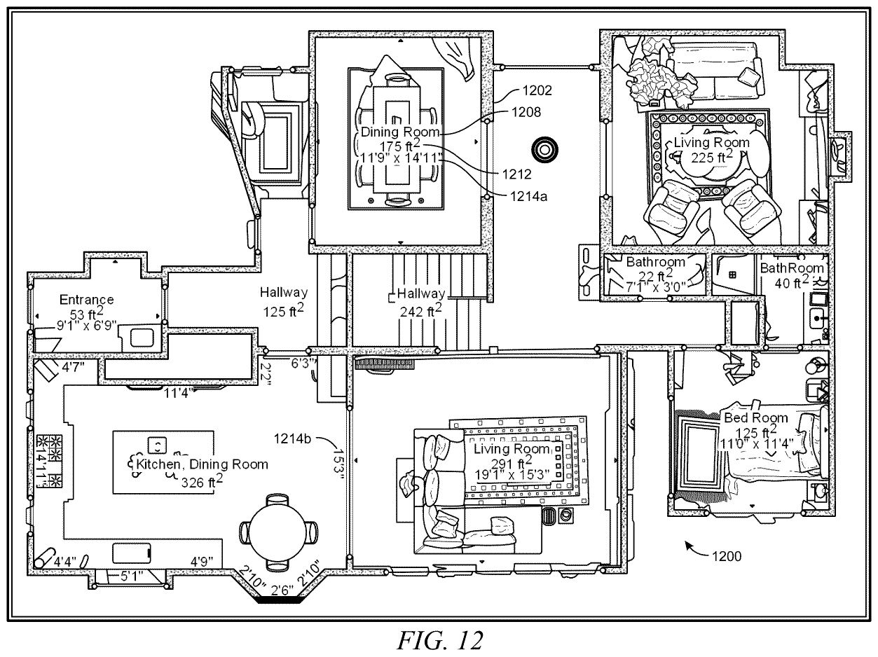

FIG. 12 depicts another 3D representation 1200 of a building along with building data. FIG. 12 depicts different types of content being combined including, for example, an orthographic, top-down view of the 3D mesh along with spatial data of the room boundaries 1202, room labels (for example, room label 1208), room dimensions (for example, room dimension 1214a), and room areas (for example, room area 1212). FIG. 12 also shows highlighting of some of the content (the kitchen/dining room in the lower left) by making that room a different color or shade and making additional content related to it visible (measurements for each wall segment, such as room dimension 1214 b). The 3D representation 1200 is also shown with building data in the form of room labels

FIG. 13 depicts an interface 1300 showing a 3D representation 1302 of an environment displayed simultaneously with another 3D representation 1306 of a building. FIG. 13 depicts a view of a neighborhood (for example, 3D map/earth content) with a view of the inside of a building visible through the building exterior. It also includes location tags with additional content combined in the same view.

The X markings of FIG. 13 (for example, marking 1308) may indicate camera locations where photorealistic views may be available. Mesh views of the map tiles or dollhouse may be available from any camera location. In some embodiments, the camera can also snap to either the orbit path or an indoor scan location. In various embodiments, at those locations the imagery may be photorealistic or at a higher quality. It will be appreciated that, in various embodiments, the user may navigate freely in dollhouse mode or snap to specific, photorealistic viewpoints and navigate between them. In some embodiments, the navigation may include a continuous, aerial orbit path (for example, path 1310) around the property that may also have photorealistic views. The aerial path may be generally circular, generally elliptical, or other generally curvilinear or linear). The path may also be at ground level or not a complete orbit (or even disconnected path sections). It will be appreciated that the user may snap to a track and move along, in addition to the individual scan point locations the user can snap to.

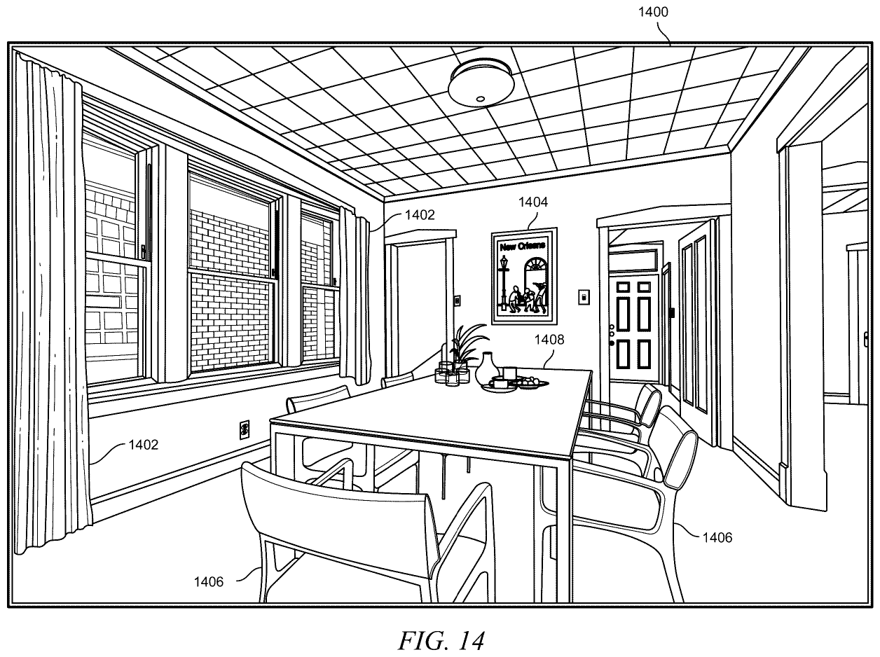

FIG. 14 depicts an interface 1400 showing a 3D representation of a room of a building along with room items identified. FIG. 14 depicts outlining and highlighting of content based on other content (in this case semantic segmentation of furniture such as chairs 1406 and table 1408, wall décor 1404, and curtains 1402) mapped to the same viewpoint.

FIG. 15 depicts another 3D representation 1500 of a building along with building data. FIG. 15 depicts many of the content elements shown in the other dollhouse view. Although not depicted in FIGS. 15, 3D surfaces may be colored according to other spatially associated content (in this case semantic segmentation of the surfaces into different classes such as wall, floor, chair, or the like). For example, in the 3D representation 1500, walls, such as wall 1504 may be colored according to a first color or range of colors, floors, such as floor 1502 may be colored according to a second color or range of colors, and other content items, such as rug 1506 and table 1508 may be colored according to a third color or range of colors or a fourth color or range of colors.

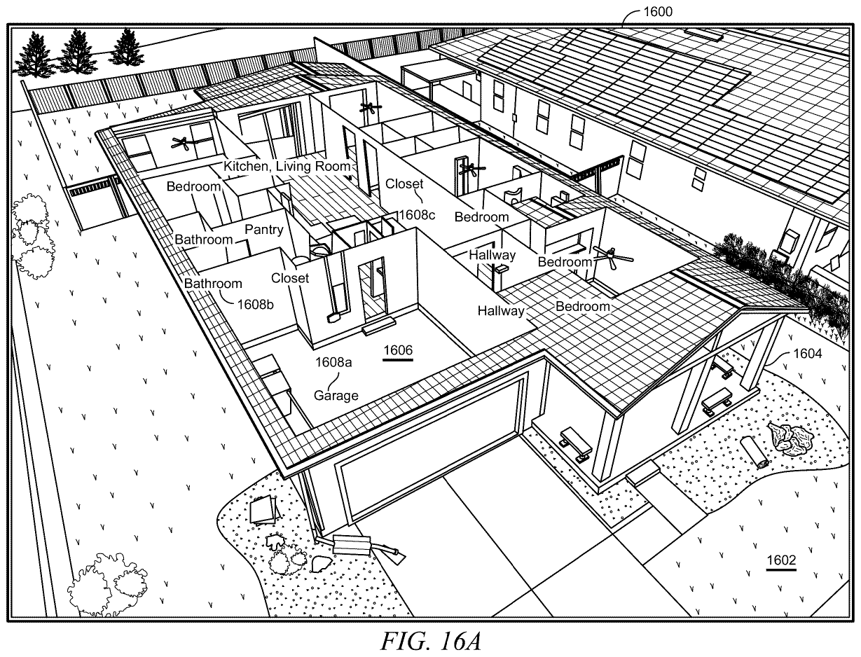

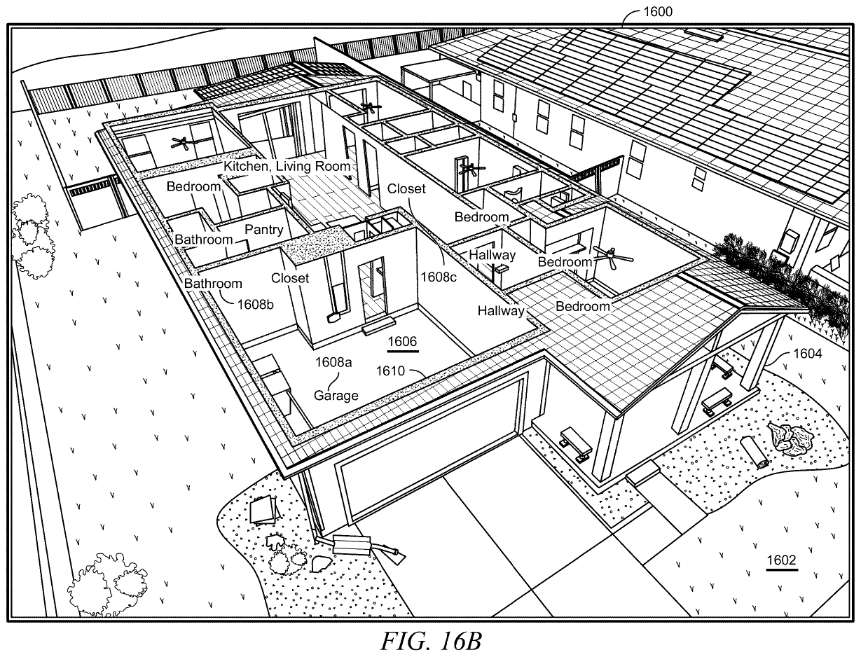

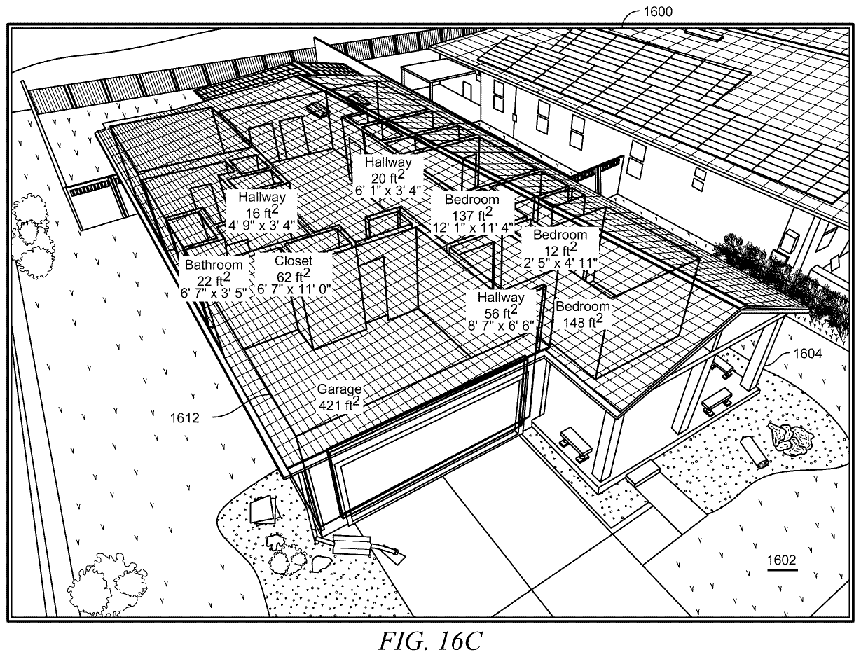

FIGS. 16A to 16C depict an interface 1600 depicting a 3D representation 1602 of an environment including a building 1604 and different 3D representations of rooms of building 1604, as well as building data. FIG. 16A depicts that a portion of the 3D representation 1602 may be hidden so as to display a portion of a 3D representation 1606 of a portion of the interior of the building 1604. In the example of FIG. 16A, the portion of the 3D representation 1602 that is hidden corresponds to a portion of the roof of the building 1604. FIG. 16A also depicts that room labels 1608 (shown individually as room label 1608a for a garage, room label 1608b for a bathroom, and room label 1608 c for a closet) are displayed overlaid on the portion of a 3D representation 1606. In some embodiments, the 3D representation 1602 may include or utilize Gaussian splats, and the 3D representation 1606 may include or utilize a 3D mesh. In some embodiments, both the 3D representation 1602 and the 3D representation 1606 may have the same type (for example, both may include or utilize Gaussian splats, or both may include or utilize a 3D mesh).

FIG. 16B also depicts the portion of the 3D representation 1602 and the portion of the 3D representation 1606 displayed in FIG. 16A, along with a portion of a 3D representation 1610 for walls or other boundary elements of the building 1604. FIG. 16C also depicts the 3D representation 1602 with a portion of a different 3D representation 1612 that is a wireframe.

FIG. 17 depicts a block diagram of an example digital device 1700 according to some embodiments. The digital device 1700 is shown in the form of a general-purpose computing device. The digital device 1700 includes at least one processor 1702, which may be or include one or more central processing units (CPUs) or one or more graphics processing units (GPUs), random access memory (RAM 1704), communication interface 1706, input/output device 1708, storage 1710, and a system bus 1712 that couples various system components including storage 1710 to the at least one processor 1702. A set (which may be a physical set or a logical set) of one or more of the digital device 1700 may be referred to as a computing system.

System bus 1712 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1700 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1702 is configured to execute executable instructions (for example, programs). In some embodiments, the at least one processor 1702 comprises circuitry or any processor capable of processing the executable instructions.

In some embodiments, RAM 1704 stores programs or data. In various embodiments, working data is stored within RAM 1704. The data within RAM 1704 may be cleared or ultimately transferred to storage 1710, such as prior to reset or powering down the digital device 1700.

In some embodiments, the digital device 1700 is coupled to a network via communication interface 1706. The digital device 1700 can communicate with one or more networks such as a local area network (LAN), a general wide area network (WAN), or a public network (for example, the Internet).

In some embodiments, input/output device 1708 is any device that inputs data (for example, mouse, keyboard, stylus, sensors, etc.) or outputs data (for example, speaker, display, virtual reality headset).

In some embodiments, storage 1710 can include computer system readable media in the form of non-volatile memory, such as read only memory (ROM), programmable read only memory (PROM), solid-state drives (SSD), flash memory, or cache memory. Storage 1710 may further include other removable/non-removable, volatile/non-volatile computer system storage media. By way of example only, storage 1710 can be provided for reading from and writing to a non-removable, non-volatile magnetic media. The storage 1710 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1712 by one or more data media interfaces. As will be further depicted and described below, storage 1710 may include at least one program product having a set (for example, at least one) of program modules that are configured to carry out the functions of embodiments of the technology. In some embodiments, RAM 1704 is found within storage 1710.

Programs/utilities, having a set (at least one) of program modules may be stored in storage 1710 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the digital device 1700. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times.

Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

88. One or more non-transitory computer-readable media comprising executable instructions, the executable instructions being executable by one or more processors to perform a method, the method comprising:
receiving images of an environment, the environment including a building, one or more of the images showing at least a portion of an exterior of the building;
generating, based on the images, a 3D representation of the environment, the 3D representation including Gaussian splats representing the environment, the 3D representation including particular regions in which a virtual camera for viewing the 3D representation moves as the 3D representation is navigated, the virtual camera constrained to move only in the particular regions, the particular regions being less than an entirety of the 3D representation; and
providing the 3D representation.

89. The one or more non-transitory computer-readable media of claim 88 wherein the virtual camera is constrained to have only particular orientations as the virtual camera moves in the particular regions in the 3D representation, the particular orientations less than an entirety of all orientations.

90. The one or more non-transitory computer-readable media of claim 89, the method further comprising identifying the particular regions in the 3D representation in which the virtual camera moves as the 3D representation is navigated.

91. The one or more non-transitory computer-readable media of claim 90, the method further comprising identifying the particular orientations that the virtual camera has as the virtual camera moves in the particular regions in the 3D representation.

92. The one or more non-transitory computer-readable media of claim 91 wherein positions, orientations, or positions and orientations in the 3D representation have quality attributes, and identifying the particular regions and the particular orientations includes identifying, based on the quality attributes, the particular regions having particular positions, orientations, or positions and orientations having quality attributes above a threshold.

93. The one or more non-transitory computer-readable media of claim 88 wherein the particular regions are identified based on capture positions of the images.

94. The one or more non-transitory computer-readable media of claim 88 wherein the 3D representation has one or more central positions, and the particular regions are identified based on the one or more central positions.

95. The one or more non-transitory computer-readable media of claim 88 wherein a building 3D representation of the building is located at a central position of the 3D representation.

96. The one or more non-transitory computer-readable media of claim 88 wherein the images were captured by a drone.

97. A method comprising:
receiving images of an environment, the environment including a building;
generating, based on the images, a 3D representation of the environment, the 3D representation including Gaussian splats representing the environment, wherein the 3D representation includes particular regions in which a virtual camera for viewing the 3D representation may move as the 3D representation is navigated, the virtual camera constrained to move only in the particular regions, the particular regions less than an entirety of the 3D representation; and
providing the 3D representation.

98. The method of claim 97 wherein the virtual camera is constrained to have only particular orientations as the virtual camera moves in the particular regions in the 3D representation, the particular orientations less than an entirety of all orientations.

99. The method of claim 98, further comprising identifying the particular regions in the 3D representation in which the virtual camera moves as the 3D representation is navigated.

100. The method of claim 99, further comprising identifying the particular orientations that the virtual camera has as the virtual camera moves in the particular regions in the 3D representation.

101. The method of claim 100 wherein positions, orientations, or positions and orientations in the 3D representation have quality attributes, and identifying the particular regions and the particular orientations includes identifying, based on the quality attributes, the particular regions having particular positions, orientations, or positions and orientations having quality attributes above a threshold.

102. The method of claim 97 wherein the particular regions are identified based on capture positions of the images.

103. The method of claim 97 wherein the 3D representation has one or more central positions, and the particular regions are identified based on the one or more central positions.

104. The method of claim 97 wherein a building 3D representation of the building is located at a central position of the 3D representation.

105. The method of claim 97 wherein the images were captured by a drone.

106. One or more non-transitory computer-readable media comprising executable instructions, the executable instructions being executable by one or more processors to perform a method, the method comprising:
receiving a 3D representation of an environment, the 3D representation including Gaussian splats representing the environment, the 3D representation including particular regions in which a virtual camera for viewing the 3D representation moves as the 3D representation is navigated, the virtual camera constrained to move only in the particular regions, the particular regions being less than an entirety of the 3D representation;
receiving one or more inputs to navigate the 3D representation; and
positioning, based on the one or more inputs, the virtual camera only in the particular regions in the 3D representation.

107. The one or more non-transitory computer-readable media of claim 106 wherein receiving the one or more inputs to navigate the 3D representation includes receiving one or more first inputs to move the virtual camera along a first path of a first type in the 3D representation and one or more second inputs to move the virtual camera along a second path of a second type in the 3D representation, the second type different from the first type.

108. The one or more non-transitory computer-readable media of claim 107, the method further comprising:
moving, based on the one or more first inputs, the virtual camera along a generally circular path around a vertical axis of the 3D representation at a generally constant altitude in the 3D representation, the vertical axis located at a central position of the 3D representation; and
aiming a yaw of the virtual camera at the central position of the 3D representation.

109. The one or more non-transitory computer-readable media of claim 107, the method further comprising changing, based on the one or more second inputs, one or more of an altitude of the virtual camera in the 3D representation, a distance of the virtual camera from a central position of the 3D representation, a pitch of the virtual camera, and a field of view of the virtual camera.

110. A method comprising:
receiving a 3D representation of an environment, the 3D representation including Gaussian splats representing the environment, wherein the 3D representation includes particular regions in which a virtual camera for viewing the 3D representation may move as the 3D representation is navigated, the virtual camera constrained to move only in the particular regions, the particular regions less than an entirety of the 3D representation;
receiving one or more inputs to navigate the 3D representation; and
positioning, based on the one or more inputs, the virtual camera only in the particular regions in the 3D representation.

111. The method of claim 110 wherein receiving the one or more inputs to navigate the 3D representation includes receiving one or more first inputs to move the virtual camera along a first path of a first type in the 3D representation and one or more second inputs to move the virtual camera along a second path of a second type, in the 3D representation, the second type different from the first type.

112. The method of claim 111, further comprising:
moving, based on the one or more first inputs, the virtual camera along a generally circular path around a vertical axis of the 3D representation at a generally constant altitude in the 3D representation, the vertical axis located at a central position of the 3D representation; and
aiming a yaw of the virtual camera at the central position of the 3D representation.

113. The method of claim 111, further comprising changing, based on the one or more second inputs, one or more of an altitude of the virtual camera in the 3D representation, a distance of the virtual camera from a central position of the 3D representation, a pitch of the virtual camera, and a field of view of the virtual camera.
